(19) United States
(12) Patent Application Publication
(10) Pub. No.: US 2025/0178791 A1
(43) Pub. Date: Jun. 5, 2025

(54) High-Outflow One-Way Pressure Relief Valves

(71) Applicant: Plitek, L.L.C., Prospect Heights, IL (US)

(72) Inventors: Karl K. Hoffman, Arlington Heights, IL (US); Robert C. Larsen, JR., Bartlett, IL (US); Ivan Cramer, Skokie, IL (US); Shabu Mathew Jacob, Mt. Prospect, IL (US)

(73) Assignee: Plitek, L.L.C., Prospect Heights, IL (US)

(21) Appl. No.: 18/529,708

(22) Filed: Dec. 5, 2023

(51) Int. Cl. B65D 33/01; F16K 17/02

(52) U.S. Cl. CPC B65D 33/01; B65D 2205/00; F16K 17/02

(57) ABSTRACT

High-outflow one-way pressure relief valves with structure unexpectedly providing high-outflow gas evacuation from a package are disclosed. Pressure relief valves of the types described herein may be applied to a product package with a flexible wall or walls, for example a package containing food products, to allow gas to escape from the package while preventing entry of ambient air into the package. The valve structure provides for a high-outflow valve which opens at a low pressure differential between pressure within the package and pressure outside the package to allow gas existent in the package to be rapidly evacuated from the package while preventing air inflow into the package. The valve enables a package to be rapidly compacted for efficient stacking, storing, palletizing, transporting, displaying of the packaged goods at a point of sale, or any other purpose for which efficient package size is wanted while also preserving and maintaining the quality of the packaged product.

### FIELD

This invention relates generally to one-way pressure relief valves for use with flexible packages, and more particularly, to pressure relief valves engineered to provide novel gas evacuation from, and contraction of, the package while also blocking entry of ambient air into the package.

### BACKGROUND

Many types of products are contained in closed flexible packages such as bags, pouches, and canisters. Examples of products packaged in these types of flexible packages include food products, medicines, agricultural products, and chemicals, just to name a few. Packages containing these and other types of goods have a three-dimensional volumetric size and occupy a three-dimensional volumetric space.

A challenge frequently facing producers of goods contained in flexible packages is the important need for the package and goods therein to be as compact as possible. By compact, it is meant that the three-dimensional volumetric size of the package is as small as possible, or at least as small as desired. A compact package with a minimized volumetric size can enable gains in efficiency in terms of stacking, storing, palletizing, packing, transporting, handling, and also displaying of the packaged goods at a point of sale because a compact package occupies less space. Reduction of the volumetric size of each package enables adjacent packages to be arranged closely together, thereby minimizing the volumetric space required for the grouping of packages.

An obstacle with respect to minimization of package size is air or other gas. For example, ambient air can be trapped within the package during the packaging process. Ambient air within the closed package can cause the package to have an exaggerated volumetric size as compared with a package not containing ambient air.

More specifically, a substantial volumetric amount of air can exist within a package after product is loaded into the package and the package is closed. The air may be present in a headspace region within the package and may also be located throughout the entire interior of the package. Air trapped in the closed package can cause the package to have a volumetric size that is unnecessarily large, and certainly not as compact as possible. By way of example only, a bag-type flexible package containing animal feed might contain trapped air occupying approximately about 15% to about 25% of the volume of the package. A flexible bag-type coffee package may contain gas occupying about 20% to about 30% of the volume of the package. Moreover, gas within the package is not limited to air. For example, a ground coffee package may include modified air including a blanket of nitrogen added during the packaging operation.

Furthermore, air or gas trapped in a package can expand under certain circumstances enlarging the volumetric size of the package and the space occupied by it. Air expansion can occur under conditions of ambient temperature increases or ambient pressure decreases. Air or gas within the package can occur in settings where ambient temperature increases relative to the location where the goods were packaged or should the package be shipped to a region of higher elevation above mean sea level (MSL) than the location where the goods were packaged. Any unwanted expansion of air within the package can undesirably cause the package to swell and to become enlarged and swollen in appearance and to thereby occupy a greater volumetric space.

Any unnecessary volumetric enlargement of a package means that each package occupies more space. Fewer of the enlarged packages can occupy any given space. And, packages which are enlarged by trapped gas can be irregular in shape rendering a stack of the packages unstable, for example when stacked on a pallet or in a storage area. Forces applied to a package, such as by stacking or handling, can cause gas trapped in the headspace or package generally to exert enormous pressure on the package, potentially causing the package to rupture and fail.

Pressure relief valves have been developed to vacate gas from within a package and to relieve excess gas pressure from within the package. Pressure relief valves may be attached to the package over a small opening or openings in the package. The pressure relief valve opens to release excess pressure from within the package and closes once the pressure has been relieved, thereby preventing inflow of ambient air into the package.

While excellent for their intended purposes, existing pressure relief valves are not effective for rapid evacuation of large volumetric amounts of air or other gas from within a package. Existent pressure relief valves restrict and limit gas outflow from the package into the ambient air outside the package. Such restriction of gas outflow is ideal for use with packages containing gas-producing goods, such as coffee, where relatively small amounts of gas must be evacuated from the package per unit time.

However, restriction of gas flow through the pressure-relief valve can be undesirable when what is wanted is rapid discharge of large volumetric amounts of air or gas from the package. Existent pressure-relief vents, which are incapable of blocking air inflow, can have a flow rate of just 2 liters per minute (L/min.), thereby taking an inordinate amount of time to adequately deflate a package to which the vent is attached. A one-way pressure relief valve, which is capable of blocking air inflow, can have a flow rate of just 0.005 L/min., thereby requiring even greater amounts of time to deflate the same package. All of this means that packages with existent vents or one-way valves cannot be immediately stacked or packed together in an optimally efficient manner.

And, there is a need for any one-way pressure relief valve to close completely after opening to prevent ambient air inflow through the valve. Contact between ambient air and product in the package should be avoided to prevent degradation of the product.

It would be an improvement in the art to provide a one-way pressure relief valve which can both rapidly allow large volumetric gas outflow from the package while also closing after pressure is relieved to prevent air inflow into the package, which would enable outflow of gas caused by gas expansion, which would enable rapid and efficient compaction of a package to facilitate stacking, storing, palletizing, packing, transporting, displaying, or other handling of the package and adjacent packages, and which would generally provide for improvements in the packaging used for many different types of goods.

### SUMMARY

The present invention relates to high-outflow one-way pressure relief valves. Valves of the types described herein include structure providing atypically large volumetric gas outflow through the valve while also unexpectedly blocking gas inflow back through the valve. When applied to a package having flexible walls, high-outflow one-way pressure relief valves of the types described herein enable the package to be contracted rapidly for efficient stacking, storing, palletizing, packing, transporting, displaying, or other handling of the package while also protecting product within the package from degradation by contact with ambient air.

In embodiments, a high-outflow one-way pressure relief valve may include a base layer having a vent allowing gas flow through the base layer and a cover layer of a flexible film overlying the base layer. Spaced apart portions of the cover layer may be secured with respect to the base layer providing for a region of the cover layer between the spaced apart portions which is unsecured to the base layer. This unattached region is referred to herein as an “unsecured region” of the cover layer. The spaced apart regions of the cover layer may be secured to the base layer by suitable attachment means such as by sonic welding and/or adhesive. Each of the base and cover layers may have peripheral edges. In some embodiments, those peripheral edges may be coextensive.

The base layer and the cover layer may define a gas flow path therebetween from the vent to the peripheral edges of the base layer and the cover layer, or at least to a peripheral edge of the cover layer, between the secured portions of the cover and base layers. A wetting fluid may be disposed in the gas flow path as an aid in fully closing the valve to block ambient air inflow through the valve. In embodiments, a particulate filter may also be associated with the gas flow path.

In certain embodiments, a strap may be provided between the base layer and the cover layer while in other embodiments the cover layer may abut the base layer with no such strap therebetween. In embodiments including a strap, the strap may be secured by an adhesive to the base layer between the secured regions of the cover layer. Such a strap may have a peripheral edge ending at least at the peripheral edge of the cover layer or to both the peripheral edge of the base layer and cover layer for embodiments with coextensive peripheral edges. A vent through the strap may be aligned with the base layer vent to enable gas flow through both the base layer and strap. Such a strap may space the unsecured region of the cover layer from any adhesive provided to secure the strap to the base layer to define the gas flow path therebetween and to allow for movement of the cover layer for gas outflow through the valve. The wetting fluid may be in the gas flow path between the strap and the cover layer. A wetting fluid provides surface tension which improves the sealing closure of cover layer blocking the gas flow path.

A port may be provided through the base layer apart from the vent through which wetting fluid may be introduced into the gas flow path, for example, between the cover and base layers or between the cover layer and strap.

A particulate filter may be provided to block particles that might enter the valve and lodge against the cover layer to thereby interfere with sealing closure of the cover layer to block the gas flow path. In examples, a particulate filter may be positioned across the vent. Such a particulate filter may comprise a filter element. A particulate filter may also be a plurality of small openings in the base layer with such openings serving as part of the vent.

Valves of the types described herein are placed in an open state by gas pressure through the vent and against the cover layer causing the cover layer to flex to allow gas outflow along the gas flow path and out of the valve. A closed state occurs when pressure decreases such that cover layer abuts the strap or the base layer blocking ambient gas inflow (i.e., reverse passage of air) or other gas back through the valve along the gas flow path.

In embodiments, the cover layer may be provided with structure and material properties that unexpectedly permit atypically high gas outflow through the gas flow path while also blocking inflow of air or another gas back through the valve. This provides for rapid evacuation of gas from a flexible package to which the valve is associated while also preventing ambient air or gas from entering the package and coming into contact with the contents of the package.

Cover layer characteristics may include a ratio of the area of the unsecured region of the cover layer to the total cover layer area. In embodiments, a ratio of the area of the unsecured region of the cover layer to the total cover layer area may be about 25% to about 50% with the unsecured region of the cover layer defining part of the gas flow path. Other characteristics of the cover layer include selection of a cover layer material with physical properties of a Young's Modulus of about 0.01 GPa to about 1.1 GPa, and a Resiliency Modulus of about 3 Jm⁻³ to about 20 Jm⁻³. The cover layer material may further have a typical value tensile strength at yield of about 850 psi to about 7500 psi and an elongation before failure of about 140% to about 800%.

When secured to a package, valves as described herein can open to provide a flow rate of at least about 4.7 Liters/minute when pressure inside the package is about 0.5 psig or greater than pressure outside the package and can provide a flow rate of at least about 28 L/min. or greater when pressure inside the package is about 1 psig or greater than pressure outside the package. Greater outflow rates are achievable in certain embodiments.

Other features and embodiments are described in the drawings and detailed description which follows.

### BRIEF DESCRIPTION OF THE DRAWINGS

Examples of high-outflow one-way pressure relief valves may be understood by reference to the following description taken in conjunction with the accompanying drawings, in which like reference numerals identify like elements throughout the different views. For convenience and brevity, like reference numbers are used for like parts amongst the embodiments. The drawings are not necessarily to scale, emphasis instead being placed upon illustrating the principles of the invention.

In the accompanying drawings:

FIG. 1 illustrates bag-type packages containing dry product with the walls of the packages enlarged by gas contained within in each package;

FIG. 2 illustrates a bag-type package including a first embodiment of a high-outflow one-way pressure relief valve according to the invention with certain surfaces of the package removed to facilitate understanding;

FIG. 3 is a top plan view of the pressure relief valve according to FIG. 2;

FIG. 4 is a bottom plan view of the pressure relief valve according to FIG. 2;

FIG. 5 is a perspective exploded view of the pressure relief valve according to FIG. 2;

FIG. 5A is a perspective exploded view of a further embodiment of a high-outflow one-way pressure relief valve according to the invention;

FIG. 6 is a side elevation exploded view of the pressure relief valve according to FIG. 2;

FIG. 7 is a section view taken along section 7-7 of FIG. 3 showing the pressure relief valve in a closed state;

FIG. 8 is a section view taken along section 7-7 of FIG. 3, but showing the pressure relief valve in an exaggerated partially open state;

FIG. 9 is a section view taken along section 7-7 of FIG. 3, but showing the pressure relief valve in a highly-exaggerated fully open state;

FIG. 10 is an enlarged view of the pressure relief valve according to detail section 10 of FIG. 7;

FIG. 11 is a perspective exploded view of yet another embodiment of a high-outflow one-way pressure relief valve according to the invention;

FIG. 12 is a section view taken along section 12-12 of FIG. 11 showing the pressure relief valve in a closed state;

FIG. 13 is a section view taken along section 12-12 of FIG. 11, but showing the pressure relief valve in a highly-exaggerated fully open state;

FIGS. 14A-14C are plan views of alternative designs of high-outflow one-way pressure relief valves according to the invention;

FIG. 15 is a plan view of four high-outflow one-way pressure relief valves arranged on a release liner; and

FIG. 16 is a plan view of a cover layer embodiment illustrating a means for determining certain cover layer ratios.

### DETAILED DESCRIPTION

The present invention relates to high-outflow one-way pressure relief valves, examples of which are indicated by reference numbers 10, 10a, 10b, 10c, 10d, and 10e throughout the figures. Such valves 10, 10a, 10b, 10c, 10d, and 10e incorporate novel structure that enables atypically rapid and large volumetric amounts of gas to escape through the valve from within a flexible package 11 when pressure within the package becomes greater than ambient pressure while also preventing entry of ambient air into the package 11 once the pressure within package 11 decreases to approximate ambient pressure outside of package 11. The term “pressure differential” is used herein to refer to the difference in pressure between pressure inside a package 11 to which a valve 10, 10a, 10b, 10c, 10d, and 10e is attached and pressure outside of package 11. Pressure within package 11 may be exerted at an inlet of valve 10, 10a, 10b, 10c, 10d, and 10e and an outlet of valve may discharge gas to the surrounding environment outside of package 11. Pressure outside of package 11 typically represents ambient pressure. The novel gas outflow characteristics of such valve embodiments 10, 10a, 10b, 10c, 10d, and 10e is referred to herein by the term “high-outflow.” Provision of both high-outflow of gas and blockage of gas inflow represents an unexpected and favorable result because it was thought that a valve capable of high gas outflow would not be capable of closing sufficiently after opening to block air inflow. For convenience and brevity, reference number 10 is used herein to identify all embodiments of valves 10, 10a, 10b, 10c, 10d, and 10e unless indicated otherwise herein.

Valves 10 of the types described herein are ideal for use in eliminating air or gas from within a package 11, such as air that may have been entrapped in the package 11 during the packaging process. The atypically rapid one-way evacuation of gas from within the package 11 enables package 11 to contract with immediacy, thus enabling efficient stacking, storing, palletizing, packing, transporting, displaying, or other handling of the contracted packages 11 while also protecting product within package 11 from contact with ambient air. In short, valves such as valves 10 provide for improvements in packaging not possible with existent valves.

Valves 10 may have a single opening and closing cycle should sufficient gas be evacuated from package 11 in the first opening. Valves 10 may have additional opening and closing cycles should additional air become entrapped in package 11, such as by opening and reclosing package 11, or if residual gas expands because of changes in temperature and pressure. Between opening cycles, valves 10 block air from entering the package 11.

### Package Examples

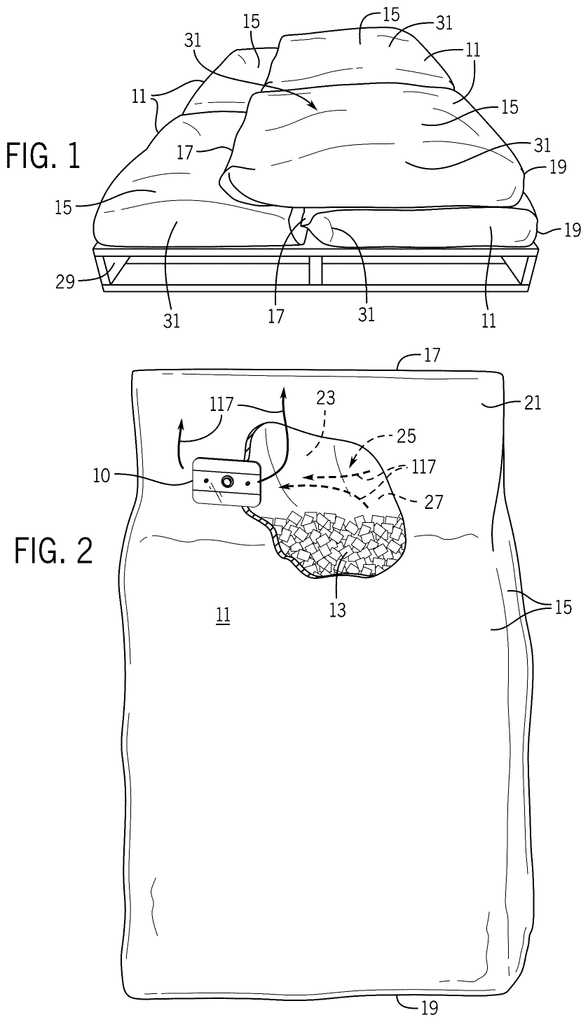

FIGS. 1-2 illustrate examples of packages 11 for which atypically fast removal of large amounts of gas from within package 11 would be of great value. Packages 11 of the types illustrated in FIGS. 1-2 may be of a type used to hold any type of product 13 such as foods, medicines, agricultural products, and chemicals. In the examples of FIGS. 1-2, package 11 contains product 13 in the form of a dry, flowable animal feed, such as dry granular dog kibble. Packages 11 of this type may have a flexible or collapsible wall 15 or walls 15. In embodiments of package 11, walls 15 may be of a flattened tubular type with closed ends 17, 19.

The flexible material used for package 11 may be selected as desired for the application. Examples of flexible materials used for packaging of food products such as dog kibble may comprise multi-layered flexible materials such as polyester (PET), polyethylene (PE), and metalized-polyester (MET PET) sheeting. These types of materials are effective at preserving freshness of the packaged product. New materials, including many sustainable materials, may also be examples of suitable products for use in manufacture of packages such as packages 11.

Bag-type packages 11 such as those illustrated in FIGS. 1-2 may be manufactured and loaded in any suitable manner, such as by means of a form-fill-seal machine. As is known, a typical form-fill-seal machine first partially closes a second end 19 (i.e., lower end) of a continuous tubular web of flexible package material, followed by loading product 13 into the package 11. Package 11 formation is completed by closing a first end 17 (i.e., upper end) of package 11 and separating the loaded package 11 from the web, all in a continuous packaging operation. Air may be entrapped within package 11 as second end 19 is closed. The finished package 11 should then be ready for immediate stacking, storing, palletizing, transporting, and possibly also for display of the packaged product at a point of sale. However, any air entrapped in package 11 during the packaging process could unnecessarily enlarge the package 11 making these types of package 11 handling operations sub-optimal and inefficient. FIG. 1 illustrates packages 11 without valves 10 in an expanded, swollen state with air trapped therein. Enlargement of each separate package 11 is amplified when plural enlarged packages 11 are stacked atop or against one another making any stacks of packages unstable and any collection of packages 11 occupy more space than might otherwise be necessary as illustrated in FIG. 1.

Referring now to FIG. 2, walls 15 of package 11 may have exterior 21 and interior 23 surfaces. Inner surfaces 23 define and bound an interior region 25 of package 11. Interior region 25 may include a head space 27 above product 13 in package 11. Interior region 25 and headspace 27 may be filled with ambient air entrapped therein during the packaging process.

FIG. 1 is illustrative of the problem resulting from air entrapped within package 11 interior region 25. FIG. 1 shows several identical packages, each of which is indicated by reference number 11 for convenience. In the example of FIG. 1, each package 11 may be for containing product 13 in the form of fifty pounds (22.7 kg ) of dry granular dog kibble. FIG. 1 illustrates packages 11 loaded on a pallet 29 typical of the type used to stack, store, and transport merchandise.

From FIG. 1 it can be seen that walls 15 of packages 11 are expanded outwardly as indicated by reference number 31. The expanded walls 15 are indicative that air is entrapped within packages 11 and that there is a pressure differential in which pressure within package 11 is greater than ambient pressure outside of package 11. Packages 11 are swollen and enlarged in appearance, meaning that packages 11 have a larger volumetric size than necessary and occupy a greater volumetric space as compared with a package not including such entrapped air. The enlarged packages 11 illustrated in FIG. 1 are irregular in shape potentially rendering a stack of the packages 11 unstable. As already noted, enlargement of separate packages 11 becomes amplified when a stack consists of many separate packages 11 making the stack of packages 11 unstable and vulnerable to collapse, for instance if additional packages 11 were stacked on pallet 29 in FIG. 1. Damage to each package 11 could occur as force against each package causes a sharp increase in air pressure within package 11 interior region 25, potentially causing package 11 or a closed end 17, 19 to separate and fail.

Flexible packages other than bag-type packages 11 may also have a need for rapid contraction with one-way gas flow out of the package. Examples can include flexible cans and canisters, rigid containers with flexible covers or seals, packs, bags, and pouches.

### Valve Location Examples

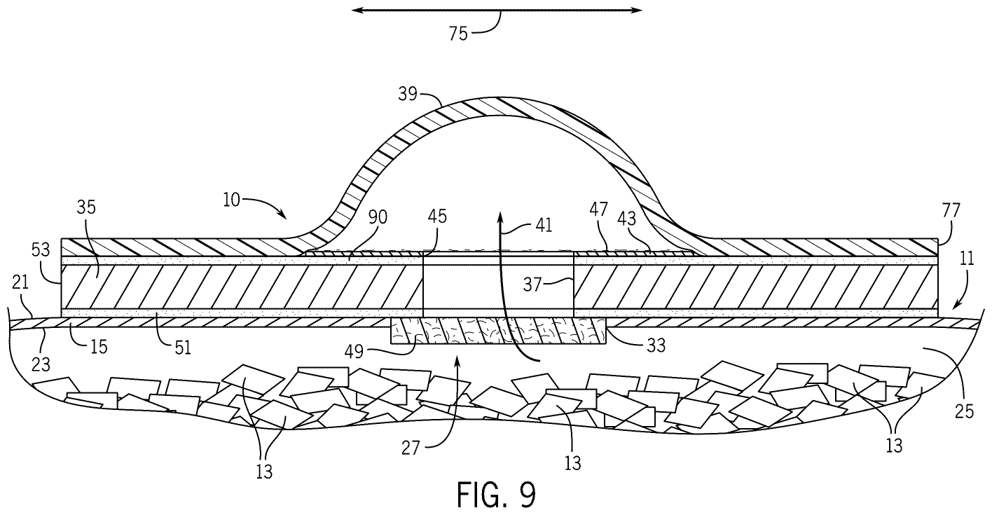

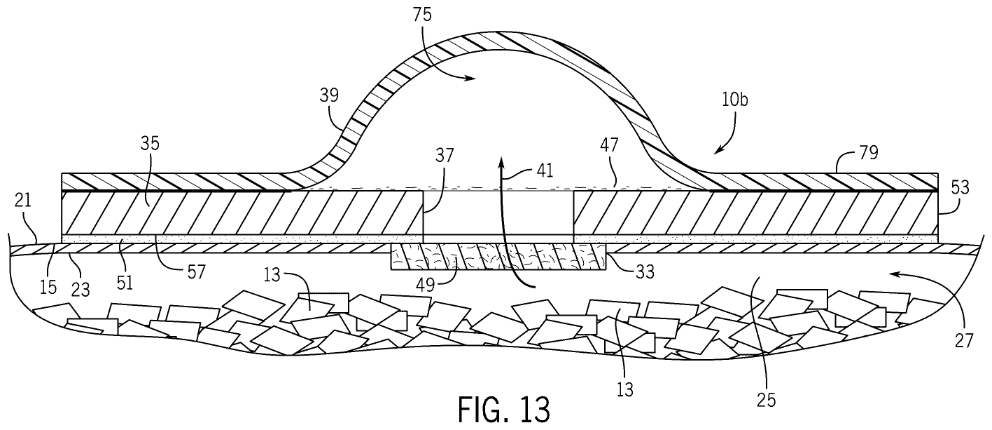

Referring to FIGS. 2, 7-9, and 12-13, pressure relief valves 10 may be affixed to exterior surface 21 of package 11 over a vent opening 33 provided entirely through package 11 wall 15. Vent opening 33 in package 11 may be a hole or holes in wall 15. Pressure relief valves 10 may be affixed to any suitable exterior surface 21 of package 11 having a vent opening 33. In suitable packages, the vent opening 33 may be located in, for example, a top, a bottom, a front, a rear, a side, a lid, a cover, or a cap of the package. Pressure relief valves 10 may also be used on an interior surface 23 of package 11 in appropriate circumstances.

### Valve Component Examples

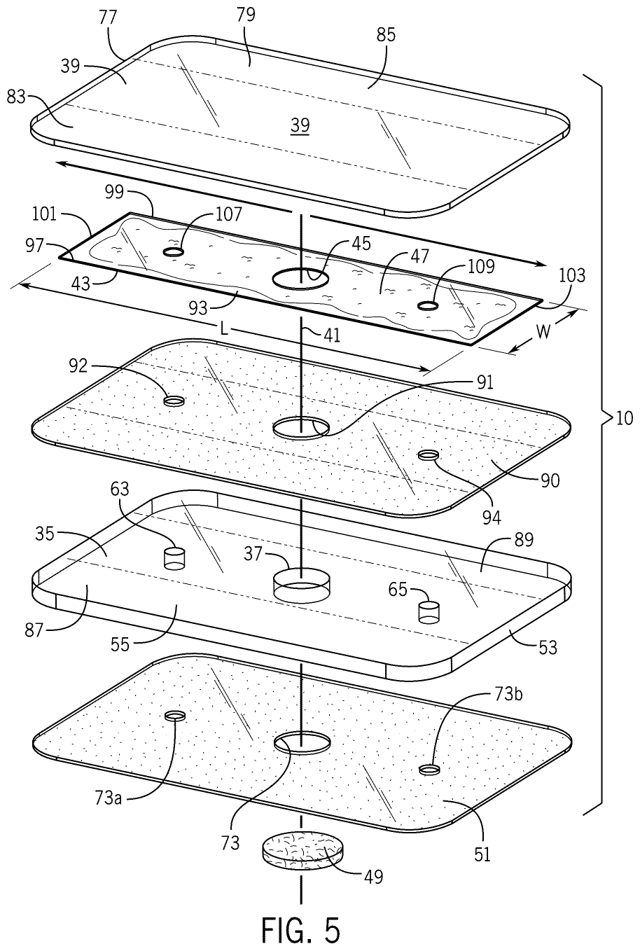

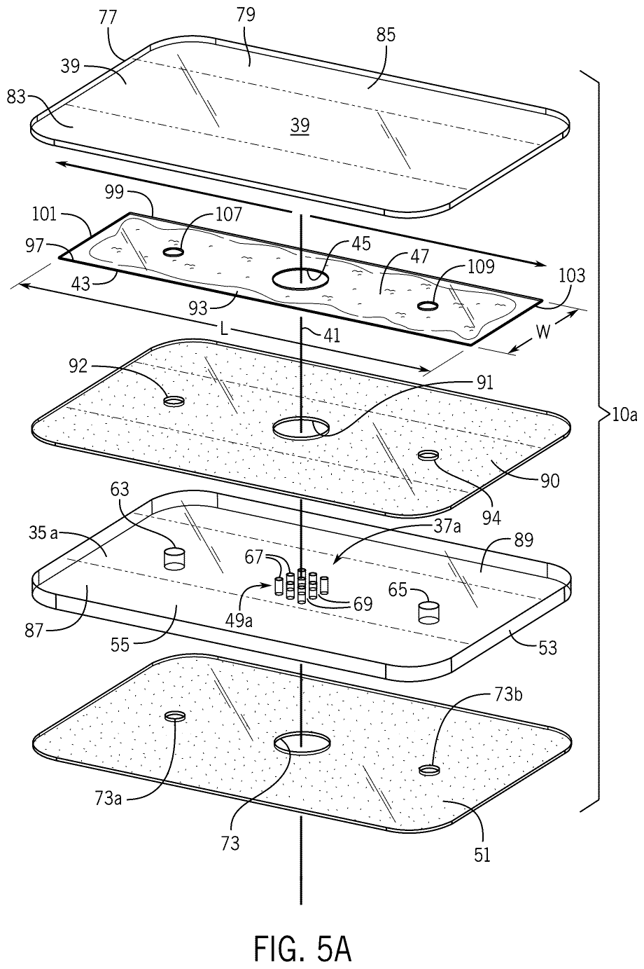

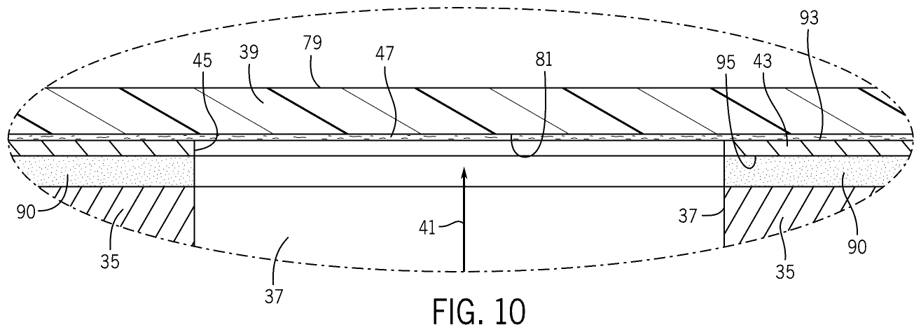

Referring now to FIGS. 2-16, components of embodiments of pressure relief valves 10 (and valves 10a-10e) will next be described. In the examples, components of valves 10 may include a base layer 35 (also considered to be a “base”) having a vent 37. In the valve embodiment 10a of FIG. 5A, base 35b is identical to base 35 except for the structure of vent 37a as described herein. Cover layer 39 (also considered to be a “cover”) overlies base layer 35. In embodiments, base layer 35 and cover layer 39 may serve to define portions of a gas flow path 41 providing a path for gas to exit through valve 10 responsive to a greater pressure within package 11 than outside package 11.

In the valve embodiment 10 of FIGS. 2-10 and 14-15, a strap 43 with a vent 45 may overlie base layer 35 and base layer 35a. In the embodiments, strap 43 is between cover layer 39 and base layer 35 or base layer 35a. Strap 43 may include a vent 45 and strap 43 may overly base layer 35, 35a such that vents 37 and 45 are aligned to define a part of gas flow path 41 enabling gas to flow through base 35, 35a, and out of valves 10 between strap 43 and cover layer 39. A wetting fluid 47 may be disposed between strap 43 and cover layer 39 and around strap vent 45. In embodiments with a strap 43, base layer 35, cover layer 39 and strap 43 may serve to define portions of gas flow path 41.

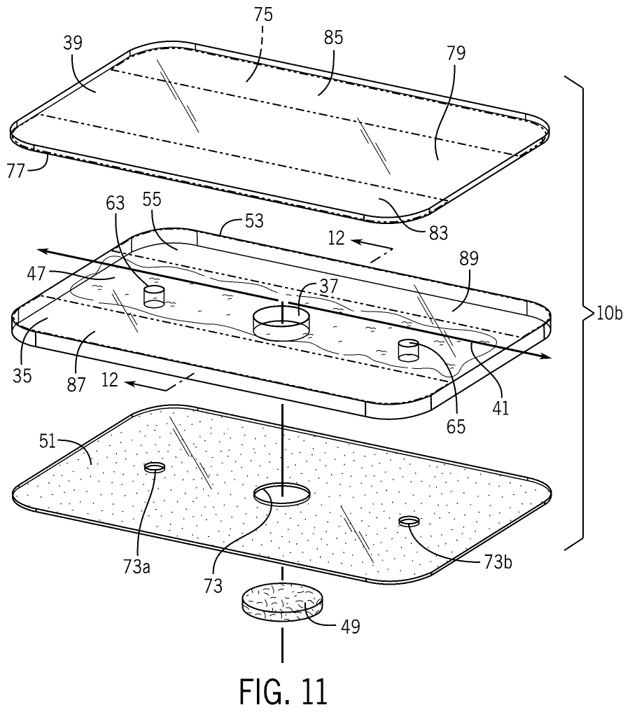

In valve embodiment 10b of FIGS. 11-13, a strap is not provided and vent 37, base layer 35, and cover layer 39 define gas flow path 41. A wetting fluid 47 may be disposed along gas flow path 41 between base layer 35, 35a and cover layer 39 around vent 37.

A particulate filter 49 (FIG. 4-5, 6-9, 11-13) or 49a (FIG. 5A) may also be provided. Particulate filter 49, 49a prevents particulates from entering base layer 35, 35a vent 37 and potentially interfering with complete closure of valves 10.

Valves 10 having structure defined herein, unexpectedly provide atypically high outflow rates of large volumetric amounts of gas at low pressure differentials inside and outside package 11 to suddenly contract package 11 while also blocking entry of gas from entering package 11 once the pressure within package 11 nears equalization with ambient pressure. Valves 10 may include other structure as described herein.

### Base Layer Examples

Referring then to FIGS. 4-14, valves 10 may include a gas-impervious base layer 35 (FIG. 4-5, 6-13) or 35a (FIG. 5A) which may also be thought of as a first layer in the examples. Base layer 35 should be of a gas-impervious material to block passage of any ambient air through base layer 35 and into package 11. FIG. 5A illustrates a further embodiment of a base layer 35a in which base layer 35a defines a vent 37a which is also a particulate filter 49a. Thus, valve embodiments 10a including base layer 35a provide particulate filtration via the base layer 35a and may not have a separate particulate filter 49 if particulate filtration is wanted. Base layer 35a may otherwise be identical to base layer 35 and, for purposes of simplicity and convenience, like reference numbers are used to indicate like parts of each base layer 35, 35a.

In the embodiments, base layer 35, 35a may provide a type of platform on which valves 10 may be constructed and which may be attached directly to package 11, for example by means of adhesive 51 as described below. The term “base layer” or “base” as used herein is intended to have a broad meaning and may include, for example, a base of a single layer of material, such as base layers 35, 35a, a laminate of multiple joined-together layers, one or more layers with a filter element (e.g., filter 49a), or other supportive structure for valves 10.

In the examples, each base layer 35, 35a may include a peripheral edge 53, a first side 55, and a second side 57. Relative to the parts comprising pressure relief valves 10, first side 55 can be considered an inner side while second side 57 can be considered an outer side.

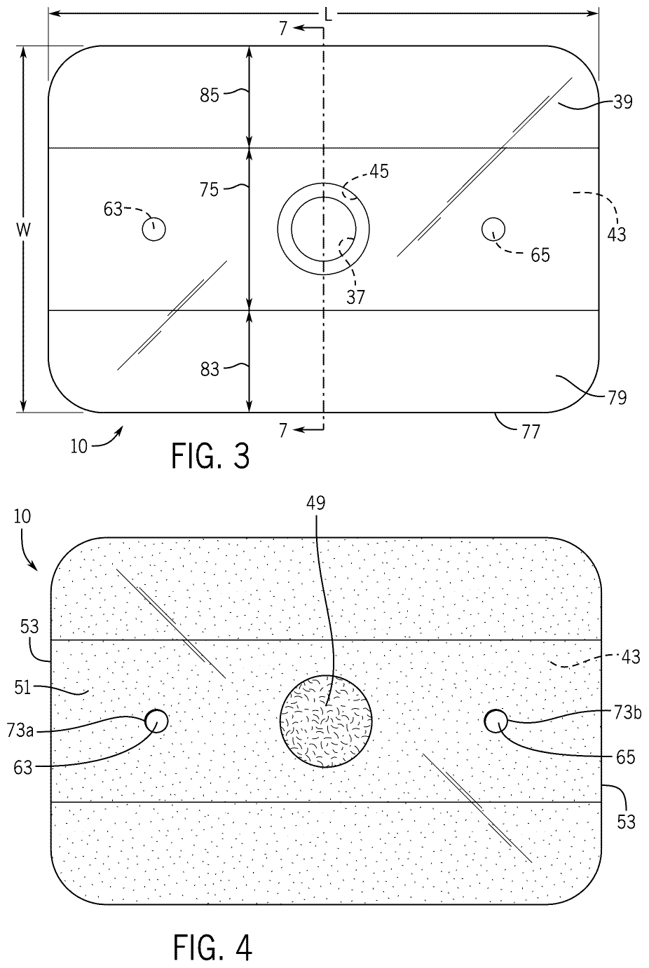

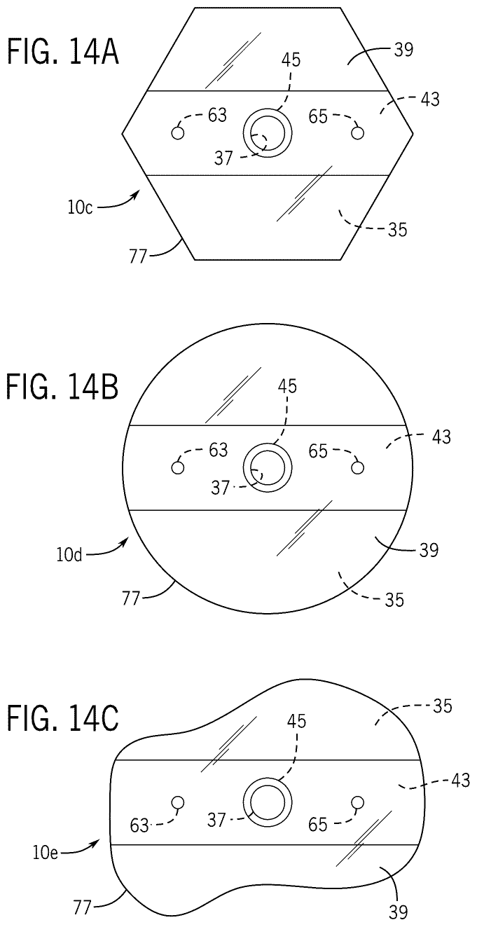

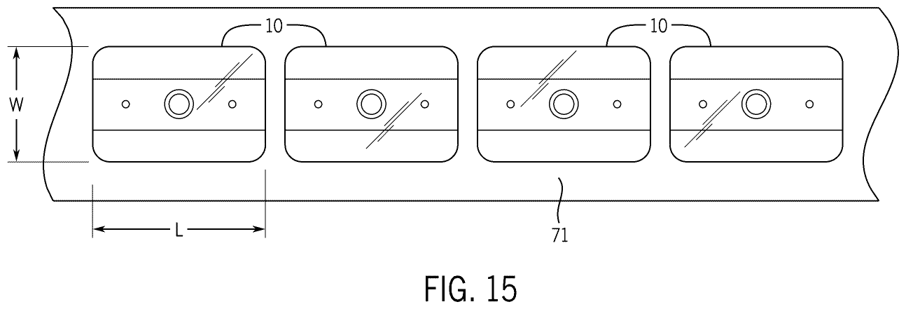

In the examples, base layer 35, 35a is generally flat, or planar, and may be made of a strip-type material. Base layer 35, 35a may include an area bounded by peripheral edge 53. Preferably, first and second sides 55, 57 of base layer 35, 35a define a plane 59 therebetween. Referring to FIGS. 3 and 15, base layer 35, 35a may have a width dimension identified by the character “W” and a length dimension identified by the character “L”. In embodiments, the width and length dimensions may define a rectangle, or another shape such as a square. In other embodiments, such as valves 10c-10d of FIGS. 14A-14C, base layer 35 may have an area defining a hexagon (valve 10c), a circle (valve 10d), or a polygon (valve 10e).

Representative materials suitable for use as base layer 35, 35a material can include polyethylene (PE), polypropylene (PP), and polyester (PET). An example of a suitable polyester is polyethylene terephthalate. The aforementioned materials are not exclusive as other suitable materials may be implemented as base layer 35, 35a. Base layer 35, 35a may have a thickness dimension between first and second sides 55, 57 in the range of about 0.00025 inches to about 0.050 inches (about 0.00635 mm to about 1.27 mm) for various iterations of valve 10, 10a. As used for quantitative values herein, “about” means or refers to the value given ±10%.

Base layer 35 may include a vent 37. Vent 37 is a type of inlet through which gas enters valve 10. In the example of FIG. 5A, base layer 35a is illustrated as including a vent 37a which is also a particulate filter 49a. Vent 37, 37a may be generally centrally disposed within peripheral edge 53 of base layer 35, 35a and may extend entirely through base layer 35, 35a, thereby allowing gas to pass through vent 37 (and vent 37a) and entirely through base layer 35, 35a only through vent 37, 37a. In the examples, valves 10 would preferably be affixed to an exterior surface 21 of package 11 with vent 37, 37a of base layer 35, 35a over and in alignment with vent opening 33 in package 11. According to these examples, vent 37, 37a provides an inlet part of a gas flow path 41 for gas within package 11 to be directed through base layer 35, 35a and into and through valve 10, 10a.

As illustrated in FIGS. 3-6, 11, and 14A-15, ports 63, 65 may be provided through base layer 35, 35a to allow wetting fluid 47 to be introduced into valve 10, 10a. Wetting fluid may be injected through ports 63, 65 before application of valve 10 to package 11.

### Particulate Filter Examples

Referring next to FIGS. 4-9 and 11-13, an optional particulate filter 49, 49a can be provided to block particulates of product 13 (e.g., kibble dust) from entering valves 10 to potentially lodge against cover layer 39 and interfere with complete closure and operation of valves 10. Incomplete closure of valves 10 can allow ambient air to enter package 11 through valves 10 in a direction opposite gas flow path 41, potentially damaging product 13 contained within package 11.

Particulate filter 49 may comprise a membrane filter of materials such as cellulose, glass fiber, mixed cellulose esters, nylon, polycarbonate, polyether sulfone, polypropylene, and other materials. Particulate filter 49 may have a pore size of less than about <1,250 μm. In certain embodiments, pore size of filter 49 may be between about 5 μm and 0.2 μm. Sigma-Aldrich Millipore® brand membrane filters are examples. Particulate filter 49 may be secured to second side 57 of base layer 35 across vent 37 by adhesive 51.

In the embodiment of FIG. 5A, particulate filter 49a of base layer 35a may include a plurality of aperture 67 and barrier 69 portions with aperture portions 67 forming vent 37. In the examples, barrier portions 69 are all parts of base layer 35a that are not aperture portions 67. Barrier portions 69 may be continuous, gas-impermeable portions of base layer 35a that serve as a barrier to movement of any particulate substance (e.g., kibble dust) through base layer 35a. Aperture portions 67 preferably consist of plural small openings in base layer 35a. To avoid obscuring the drawings, just several of such small apertures are indicated by reference number 67. In the examples of base layer 35a, nine apertures 67 are illustrated. The nine apertures 67 are shown in three evenly-spaced rows and columns. Aperture portions 67 may be sized to block particles which may be about 300 μm or less in size. In embodiments, apertures 67 may be about 0.020 inches (about 0.508 mm) in diameter. Aperture portions 67 may be formed by any appropriate means, such as by laser drilling or punching.

It is to be understood that any suitable particulate filter may be implemented if a filter is desired. The pore size and material, or the number, size, spacing, and arrangement of apertures, may be as appropriate for a given product 13 and particulate filters 49, 49a are merely illustrative. Circles, chevrons, x-shaped apertures, and combinations of shapes and sizes of apertures 67 may be implemented. Even spacing is optional as apertures 67 may be randomly distributed across base layer 35a.

### Adhesive Examples

Referring next to FIGS. 4-9 and 11-13 adhesive 51 may be provided on base layer 35, 35a second side 57 (i.e., an outer side) to both removably mount base layer 35, 35a and valves 10 on release liner 71 (FIG. 15) and to permanently attach base layer 35, 35a and valves 10 to a package 11, as illustrated, for example, in FIGS. 2, 7-9, and 12-13. Edge 73 of adhesive 51 may surround vent 37 (and apertures 67) and edges 73a, 73b surround a respective port 63, 65 of base layer 35, 35a. Edge 73 and adhesive 51 block any lateral gas or air movement between valve 10, 10a and package 11. Adhesive 51 may be in a layer of about 0.00025 inch to about 0.015 inch (about 0.00635 mm to about 0.381 mm) in thickness. By way of example, types of adhesives which may be utilized include pressure-sensitive adhesives (PSAs), heat-activated adhesives, ultraviolet cured adhesives, water-based adhesives, solvent-based adhesives, and rubber-based adhesives. Oleophobic adhesives, such as acrylic adhesives, are particularly preferred because they can be selected and/or formulated to resist degradation when exposed to certain types of wetting fluids.

### Cover Layer Examples

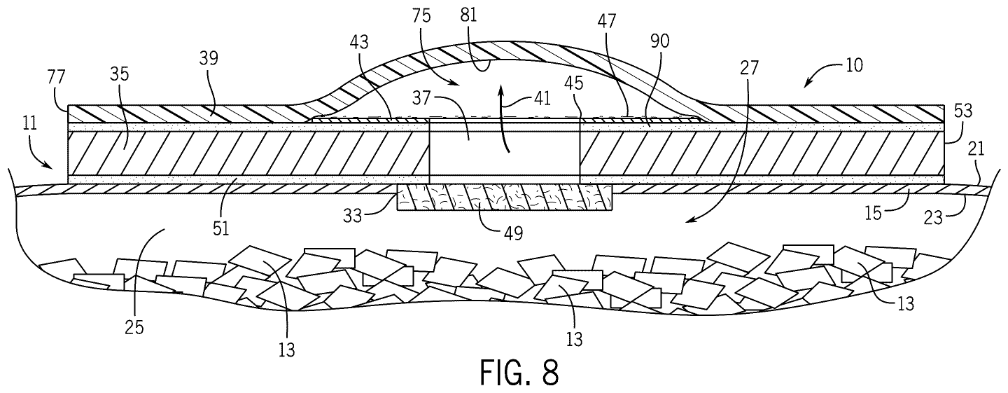

The unexpected advantages of valve 10 (and valves 10a-10e) with respect to providing both high outflow of gas while blocking inflow of gas are believed to be made possible in part because of the relationship of cover layer 39 and base layer 35, 35a and the structure of cover layer 39 itself. The relationship of cover layer 39 and base layer 35, 35a, is such that cover layer 39 is provided with an “unsecured region” 75 of a defined type which is free of attachment to base layer 35, 35a and is able to flex and to move at least partially away from base layer 35, 35a first side 55 when valves 10 are in the open state of FIGS. 2, 8-9 and 13 to permit large and rapid volumetric amounts of gas flow out of valves 10 and along gas flow path 41. FIGS. 8-9 and 13 are of a schematic nature and show the open state in a highly exaggerated form; these figures are not intended to represent the actual appearance of valves 10 to the human eye when in the open state. The structure of cover layer 39 is defined by certain important material properties as described herein. The combination of these characteristics is believed to provide valves 10 (and valves 10a-10e) with novel structure providing both the high outflow of gas and blockage of gas inflow.

In the examples and referring to FIGS. 3-14, cover layer 39 of valves 10 overlies base layer 35, 35a. In the examples, cover layer 39 includes peripheral edge 77, a first side 79 and a second side 81. Relative to base layer 35, 35a, first side 79 of cover layer 39 may be considered an outer side, while second side 81 of cover layer 39 toward base layer 35, 35a can be considered an inner side. Cover layer 39 may have a width dimension W and length dimension L (FIGS. 3, 15, 16) which approximate the width W and length L dimensions of base layer 35, 35a. Cover layer 39 peripheral edge 77 may be, but is not required to be, coextensive with base layer 35, 35a peripheral edge 53 as illustrated in FIGS. 2-9 and 11-15. Such edges 53 and 77 provide an outlet for gas to exit valves 10 where cover layer edge 77 is unsecured to base layer 35. In certain other embodiments, peripheral edge 77 of cover layer 39 could be set back from peripheral edge 53 of base layer 35, 35a, for example along gas flow path 41 providing an outlet of valve 10 where gas exits valve 10 so that gas would flow at least to the peripheral edge 77 of cover layer 39. The dimensions of cover layer 39 define a cover layer area. Cover layer 39 should be of a gas-impervious material to prevent passage of any ambient air and moisture through cover layer 39 and into valves and possibly into package 11.

Referring to FIGS. 3, 5, 5A, 11, and 16, attachment regions 83, 85 of cover layer 39 on the second side 81 of cover layer 39 may be joined to attachment regions 87, 89 of base layer 35, 35a by adhesive layer 91. In the examples, attachment regions 87, 89 may be spaced apart regions of first side 55 of base layer 35, 35a. Cover layer 39 is unattached to base layer 35, 35a between attachment regions 87, 89 with the unattached portion of cover being the unsecured region 75.

### Embodiments Including a Strap

The valve embodiments 10, 10a of FIGS. 3-10 include a strap 43 and cover layer 39 cooperates with base layer 35, 35a and with strap 43 to control operation of valve 10, 10a. In the embodiments, strap 43 may be provided with novel structure not found in other one-way pressure relief valves. Specifically, strap 43 may be secured to first side 55 of base layer 35 rather than securement to cover layer 39, as is typically the case with one-way pressure relief valves. Adhesive 90 may be applied to base layer 35, 35a first side 55 entirely around vent 37, 37a to secure strap 43 to base layer 35 with strap vent 45 aligned with base layer vent 37, 37a to allow gas flow through both vents 37a or 37b and 45. Adhesive 90 may include an adhesive edge 91 which surrounds vent 37, 37a and edges 92, 94 surrounding respective ports 63, 65 to prevent gas movement between base layer 35, 35a and strap 43.

Adhesive 90 may be of the same adhesive material as previously described in connection with adhesive 51. By way of example, adhesive 90 may be in a layer of about 0.00025 inch to about 0.015 inch (about 0.00635 mm to about 0.381 mm) in thickness. In the embodiment of valve 10, strap 43 serves as a sort of barrier or “mask” separating and spacing cover layer 39 second side 81 from adhesive 91, thereby allowing for sufficient movement of cover layer 39 along unsecured region 75 to enable gas evacuation along the portions of gas flow path 41 from vent 45 and between strap 43 and cover layer 39 second side 81 bounded laterally by attachment regions 83, 85, 87, 89 joined together by adhesive 90 as described herein.

In the example of valves 10, 10a, strap 43 may have a first, or outer side 93 facing toward cover layer 39 second side 81 and a second, or inner, side 95 facing toward base layer 35, 35a first side 55. Referring to FIGS. 5 and 5A, strap 43 may have a width dimension W between opposite sides 97, 99 of strap 43 which is less than the width dimension W of base layer 35, enabling attachment regions 83, 85 of cover layer 39 to be secured to corresponding attachment regions 87, 89 of base layer 35, 35a by adhesive 90 with unsecured region 75 of cover layer 39 lying across strap 43. Strap 43 may have outer peripheral edges 101, 103 defining a length dimension L therebetween which is the same as the length L dimension of base layer 35, 35a (FIGS. 3, 5, 5A). Preferably, each outer edge 101, 103 of strap 43 extends all the way to meet peripheral edge 53 of base layer 35, 35a and also peripheral edge 77 of cover layer 39. Or, outer edge 101 or 103 could extend all the way to meet at least cover layer peripheral edge 77. Strap 43 may have a thickness dimension of about 0.0005 inch to about 0.002 inch (about 0.0127 mm to about 0.0508 mm) in thickness.

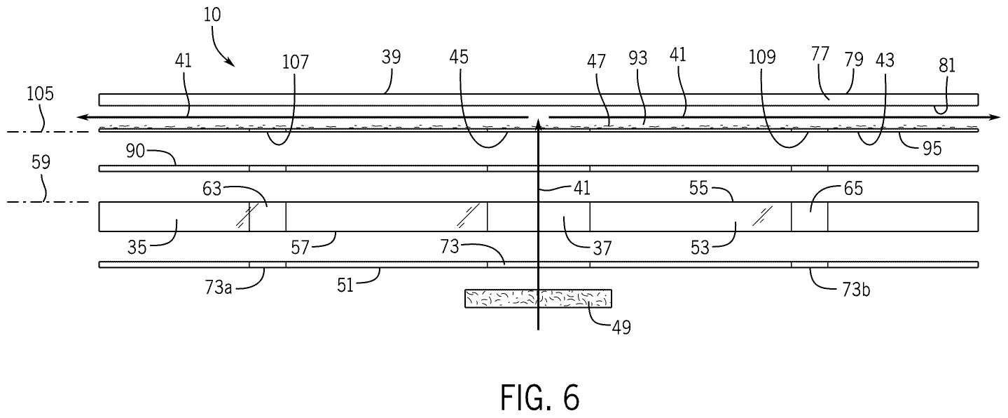

As illustrated in FIG. 6, strap 43 may define a plane 105 parallel to plane 59 of base layer 35, 35a. Ports 107, 109 may be provided through strap 43 aligned with ports 63, 65 of base layer 35, 35a to allow wetting fluid 47 to be introduced into valve 10, 10a between strap 43 and cover layer 39 and around vent 45 during the process of applying valve 10 to package 11. Securement of valve 10, 10a to release liner 71 or package 11 prevents leakage of wetting fluid 47 through ports 63, 65, 107, 109.

Strap 43 should be of a gas-impervious material to avoid passage of gas through strap 43. Representative materials suitable for use as strap 43 material may be the same as base layer 35, 35a and can include PE, PP, PET, or other suitable material.

Valve embodiments 10c, 10d, and 10e may have a structure identical to that described for valves 10, 10, except that valves 10c, 10d, and 10e have shapes which differ from those of valves 10, 10a as is evident from FIGS. 14A-14C.

### Embodiments Not Including a Strap

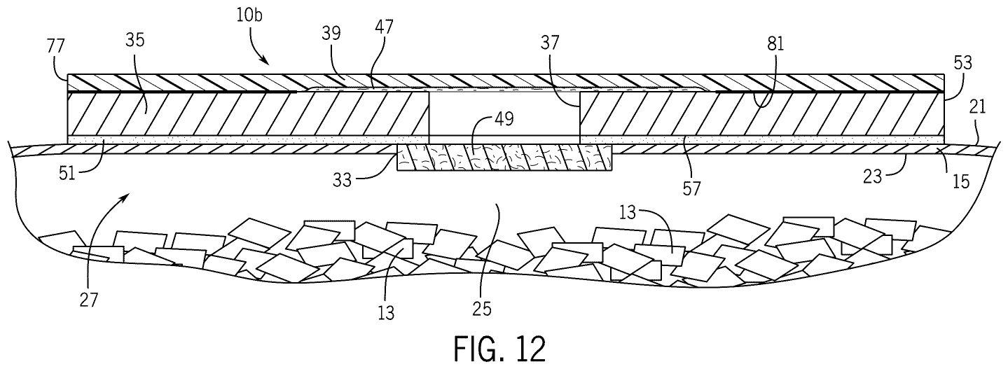

The valve embodiment 10b of FIGS. 11-13 does not include a strap 43. According to the embodiment of valve 10b, cover layer 39 cooperates with base layer 35 first side 55 to control operation of valve 10b. In this embodiment, cover layer 39, base layer 35, and wetting fluid 47 may be as described in connection with valve 10 and the description of such structure is incorporated by reference. According to the valve 10b embodiment of FIGS. 11-12, a strap 43 secured to base 35 by adhesive 90 is not provided. In the embodiment, attachment regions 83, 85 of cover layer 39 on the second side 81 of cover layer 39 may be joined to all or essentially all of attachment regions 87, 89 of base layer 35 by sonic welding or any other suitable joining means. Cover layer 39 is unattached to base layer 35 between attachment regions 83, 85, 87, 89 with the unattached portion of cover layer 39 being unsecured region 75.

Use of sonic welding or like techniques of joining cover layer 39 to base layer 35 along attachment regions 83, 85, 87, 89 enables second side 81 of cover layer 39 to lie flush against first side 55 of base layer 35 with unsecured region 75 of cover lying between attachment regions 83, 85, 87, 89, thereby allowing for sufficient movement of cover layer 39 to enable gas evacuation along the portions of gas flow path 41 between base layer 35 and cover layer 39 bounded laterally by attachment regions 83, 85, 87, 89 and cover layer 39 secured thereto as described herein while also enabling cover layer 39 to seal tightly against base layer 35 to close valve 10b. Ports 63, 65 of base layer 35 allow wetting fluid 47 to be introduced into valve 10b between base layer 35 first side 55 and cover layer 39 second side 81.

### Examples of Cover Layer Properties

Cover layer 39 is engineered to have unique physical properties which contribute to both the high outflow of gas and blockage of gas inflow. Engineered cover layer 39 must be capable of one opening and closing cycle, but may also be capable of additional opening and closing cycles should pressure within a package exceed the target pressure differential with ambient pressure after the first opening cycle.

Cover layer 39 may be made of a strip-type material (i.e., a film). While a cover layer 39 of a single layer of material is shown, other structure is envisioned, such as implementation of cover layer 39 as a plural-layer laminate. In embodiments, cover layer 39 may have a thickness dimension between first and second sides 79, 81 of about 0.0005 inch to about 0.010 inch (about 0.0127 mm to about 0.254 mm).

Cover layer 39 must have material properties and structure such that cover layer 39 is sufficiently flexible to allow high gas outflow and yet disallow gas inflow. Two important and required material properties of cover layer 39 are characteristics expressed by the Young's Modulus and the Resiliency Modulus. Young's Modulus means or refers to a measure of elasticity, equal to the ratio of the stress acting on a substance to the strain produced and may be expressed in units of Gigapascals (GPa). In the present application, values of Young's moduli were determined using ASTM D882. A Young's Modulus of about 0.01 GPa to about 1.1 GPa is believed to be important to provide the desired operation of the valve.

Resilience, of course, means or refers to the ability of a material to absorb energy when it is deformed elastically, and to release that energy upon unloading. The Modulus of Resilience means or refers to the maximum energy that can be absorbed per unit volume without creating a permanent distortion which may be expressed in units of joule per cubic meter (Jm⁻³). It is the area under the stress/strain curve up to yield deformation. ASTM D882 is the applicable standard for determining the Resiliency Modulus. The elastic potential energy and likelihood of the material to rebound is greater as the Resiliency Modulus increases. A Resiliency Modulus of about 3 Jm⁻³ to about 20 Jm⁻³ is believed to be important to provide the desired operation of the valve. Further, it is thought that the combination of the aforementioned Young's and Resiliency Moduli are important to achieving the desired operational results.

Another material property of cover layer 39 which may contribute to the novel performance of valves 10 is typical value tensile strength at yield. Tensile strength means or refers to the stress that a material can withstand while being stretched or pulled before breaking, measured in units of force per unit area such as psi. A useful range of tensile strength at yield may be in a range of about 850 psi to about 7,500 psi with a preferred range being about 1,000 psi to about 3,000 psi and a value of about 2,250 psi being highly preferred.

A related property of cover layer 39 material which may contribute to the novel performance of valves 10 is the property of an elongation before failure or break. Elongation before failure may be determined using ASTM D882. An elongation before failure of about 140% to 800% represents a useful range.

Materials with at least Young's Modulus and the Resiliency Modulus properties yield a cover layer 39 which flexes or stretches on a microscopic level to allow the high amounts of gas outflow while also having sufficient tensile strength to exert a force against strap 43 or base layer 35 sufficient to close vents 45, 37 of valve 10 or just vent 37 of valve 10b preventing entry of ambient air back into valve 10, 10b.

In combination with at least the aforementioned Young's Modulus and Resiliency Modulus, structure believed to enable the unexpected opening and closing properties of valves 10 is a ratio of an area comprising the area of the unsecured region 75 of cover layer 39 to the overall area of cover layer 39. The ratio defines an unsecured region 75 of cover layer 39 which is both sufficient to flex to allow for the rapid outflow of gas while blocking inflow of ambient air. A ratio of the area of unsecured region 75 of cover layer 39 to the overall area of cover layer 39 may lie within a range of about 25% to about 50% of the total cover layer area.

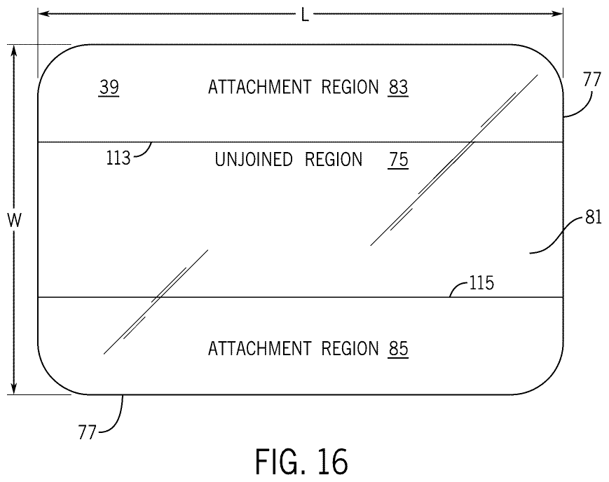

FIG. 16 is provided solely as an example by which the aforementioned ratio of the area of unsecured region 75 of cover layer 39 to the total area of cover layer 39 may be understood. FIG. 16 shows an enlarged cover layer 39 viewed toward second side 81 of cover layer 39. FIG. 16 illustrates the location of attachment regions 83, 85 bounded by peripheral edge 77 of cover layer 39 and parallel lines 113, 115. Attachment regions 83, 85 may be attached to a base such as base 35 or base 35a by adhesive 91 with strap 43 between parallel lines 113, 115. In the example, unsecured region 75 of cover layer 39 may lie between parallel lines 113, 115 bounded by attachment regions 83, 85 along the entire length dimension L of cover layer 39. In the example of FIG. 16, the approximate total area of the entire cover layer 39 may be about 1.5 in² based on a length dimension L of 1.5″ and a width dimension W of 1″ (i.e., an area of about 925 mm² based on a length dimension L of 38.1 mm and a width dimension W of about 25.4 mm). The area of unsecured region 75 may be about 0.375 in² to about 0.75 in² (231 mm² to about 462 mm²), providing for a ratio of the area of unsecured region 75 to the total area of cover layer 39 of about 25% to about 50%.

Film-type materials which may be used for a cover layer 39 having the needed material properties may include: (a) low-density polyethylene (LDPE) copolymerized with between about 2% to about 25% by weight ethylene vinyl acetate (EVA), (b) an ethylene methyl acrylate copolymer (EMA) with a methyl acrylate content of about 15% by weight to about 25% by weight, and (c) biaxial oriented polypropylene (BOPP).

In certain embodiments using an LDPE material, the LDPE may be copolymerized with between about 2% to about 10% by weight EVA. Copolymerization of the LDPE with about 8.7% EVA is thought to provide a particularly desirable material.

In certain embodiments using an EMA material, the EMA may have a methyl acrylate content of about 21% by weight to about 22% by weight. EMA with a 21.5% by weight % methyl acrylate content is thought to represent a particularly desirable material.

LDPE copolymerized with EVA and EMA are both available from ExxonMobil under the tradenames LDPE LD 319.PM and Optema, respectively.

### Wetting Fluid Examples

A wetting fluid 47 may be observed in FIGS. 5-13. Valves 10 of the type described herein may be engineered for use with a wetting fluid 47 for the purpose of improving sealing closure of valves after opening. Wetting fluid 47 in combination with the engineered properties of cover layer 39 and other components of valves 10 imparts excellent performance benefits to valves 10 including the excellent airtight seal of the valves 10 even after outflow of high volumetric amounts of gas through valves 10. Valves 10 including a wetting fluid 47 can be engineered to open and close at predictable, low pressures as described herein.

Wetting fluid 47 facilitates closure of cover layer 39 against strap 43 in valves 10 (and valves 10a and 10c-10e) and closure of cover layer 39 against base layer 35 in valve 10b to completely block ambient air entry into each valve 10, 10a, 10b, 10c, 10d, 10e. In the examples, wetting fluid 47 of valves 10, 10a wets first side 93 of strap 43 (i.e., the inner side) around vent 45 and second side 81 of cover layer 39. In the example of valve 10b, wetting fluid wets first side 55 of base layer 35 around vent 37 and second side 81 of cover. Wetting fluid 47 provides a surface tension which improves the aforementioned sealing closure of cover layer 39 to strap 43 or of cover layer 39 to base layer 35. Wetting fluid 47 may be deposited between cover layer 39 and strap 43 (FIGS. 3-10 and FIGS. 14A-15) or between cover layer 39 and first side 55 of base layer 35, 35a (FIGS. 11-13) through ports 63, 65, 107, 109 and completely around vent 37 or vent 45. In the embodiment of base layer 35a (FIG. 5A), wetting fluid 47 may be deposited on barrier portions 69 between apertures 67 to facilitate closure of valves 10.

By way of non-limiting example, about 1.5 μL to in excess of about 5 μL of wetting fluid 47 may be used. For example, 5 μL of wetting fluid 47 may be used for a valve with an area of about 1.5 in² as exemplified in FIG. 16. Examples of wetting fluid 47 may be silicone oil such as polydimethylsiloxane (PDMS), a graphite impregnated oil, a food grade oil, food grade silicone grease, or other viscous fluid as previously described. An example of a viscosity range of wetting fluid 47 may be about 50 centipoise (“cP”) to about 350 cP, with a more preferred range being about 100 cP to about 200 cP. PDMS, as an example, has a viscosity of about 100 cP which is within the ranges.

### Operating Pressure Range and Gas Outflow

Valve 10 (and valves 10a-10e), according to the invention may be engineered to provide about a 4.7 L/min. flow rate or greater when the pressure differential, that is the difference between pressure inside package 11 and outside package 11, is such that pressure inside package 11 exceeds pressure outside package 11 by about 0.5 psig (about 3,448 Pascals (Pa)) to permit gas outflow through the gas flow path 41 and out of valves 10 as shown in Table 4B below. However, much greater flow rates can be achieved with valves according to the invention. Flow rates of about 28 to about 49 L/min. can be achieved when pressure inside package 11 is about 1 psig (about 6,896 Pa) greater than pressure outside package 11 as shown, for example, in Tables 1 and 2 below.

Valve 10 closure may occur when pressure inside package 11 decreases following evacuation of gas from within the package 11 and the valve closes under the tensile force of cover layer 39 and surface adhesion between cover layer 39 and strap 43 or cover layer 39 and base layer 35, 35a provided by wetting fluid 47. Closure may occur when pressure inside package 11 exceeds pressure outside package 11 in the range of about 0.010 psig to about 0.070 psig greater than ambient to thereby block entry of ambient air back into valves 10.

### Alternative Valve Shapes

Referring to FIGS. 14A, 14B, and 14C, valves 10c-10e with properties of both high outflow of gas with blocked inflow of gas may have shapes other than the rectangular shapes (i.e., square shapes) illustrated in FIGS. 2-13 and 15. As illustrated in FIGS. 14A-14C, valves may have hexagonal shapes 10c, circular shapes 10d, or polygonal shapes 10e. Other than the shape, valves 10c-10e may have the structure and operation as valves 10, 10a, or 10b and the description of such valves 10, 10a, 10b is incorporated herein by reference with respect to valves 10c-10e.

### Release Liner Examples

Referring now to FIG. 15, an exemplary series of four pressure relief valves, each indicated with reference number 10 for convenience, are shown mounted on a fragment of a release liner 71. Each such valve 10 of FIG. 15 may be mounted to release liner 71 in an identical manner.

Valves 10 may be removed from release liner 71 and may be attached to a package, such as package 11 of FIGS. 1-2. Release liner 71 may be of a material to which adhesive 51 can temporarily attach valves 10 without damaging adhesive 51. Release liner 71 carries pressure relief valves 10 until the valves 10 are removed during the process of attaching valves 10 to a package 11, for example by automated application equipment. As illustrated in FIG. 15, valves 10 may be conveniently spaced apart at regular intervals along release liner 71, as for example, at about a 25 mm interval (about a 1″ interval) between centers, although the repeat spacing is also dependent on the packaging application. Wetting fluid 47 may be injected through ports 63, 65 by an applicator machine after valves 10 are removed from release liner 71 and before application to package 11.

### Operation

Referring to FIGS. 1-16, operation of valves 10, that is valves 10, 10a, 10b, 10c, 10d, 10e, will now be described. Valves 10 may function in a single opening and closing cycle or may operate in more than one opening and closing cycle depending on the volumetric amount of gas in package 11 and the differential pressure of gas in package 11 relative to ambient pressure. Pressure increases within package 11 may be caused by external forces applied against package 11 walls 15, such as can occur during stacking, storing, palletizing, packing, transporting, or handling of the package 11 as seen, for example, in FIG. 1 and the stacked palletized packages 11. Pressure increases within package 11 can also occur from environmental factors such as temperature increases or ambient pressure decreases.

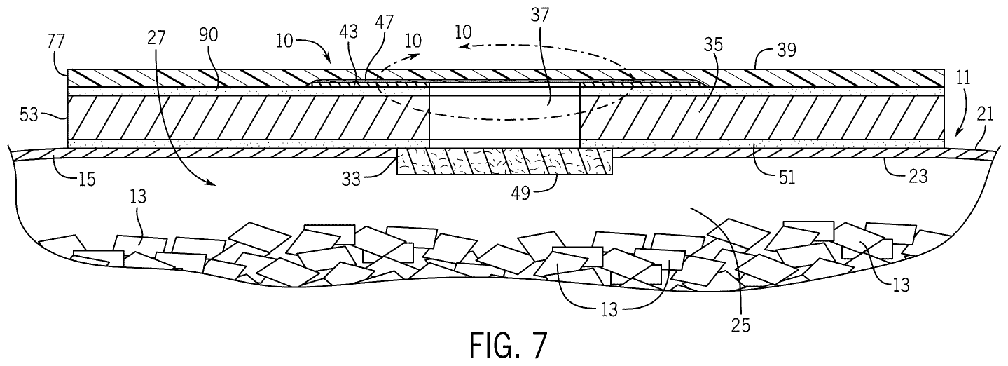

In operation, pressure relief valves 10 are initially affixed to a package 11 such as illustrated in FIG. 2. Vents 33, 37, and 45 or vents 33 and 37 are aligned with vent 33 in package 11 to provide part of gas flow path 41. Valves 10 may be applied to package 11 automatically by an applicator machine. In embodiments, particulate filter 49 may fit entirely within vent 33 as illustrated in the examples of FIGS. 7-9 and 12-13.

Initially, valves 10 are in a first, or closed, state similar to that shown in FIGS. 7 and 12. For valves 10 including a strap 43, second side 81 of cover layer 39 may abut first side 93 of strap 43 with wetting fluid 47 surrounding vent 45 of strap 43 blocking entry of air along gas flow path 41. For valves such as valve 10b, the second side 81 of cover layer 39 may abut the first side 55 of base layer 35 with wetting fluid 47 surrounding vent 37 also blocking air movement into valves 10. Wetting fluid 47 provides surface adhesion between cover layer 39 and strap 43 (FIG. 7) and between cover layer 39 and base layer 35 (FIG. 12) with cover layer 39 providing a force which serves to urge cover layer 39 sealingly against strap 43 or base layer 35, thereby blocking inflow movement of gas through vents 33, 37, and 45 or vents 33 and 37 and preserving the freshness of product 13 (i.e., kibble) or other material inside package 11 which might otherwise be degraded by contact with ambient air.

Referring to FIGS. 1-2 and FIGS. 8-9 and 13, when pressure inside package 11 builds to exceed the predetermined and known target pressure (e.g., about 0.1 or about 0.2 psig or about 690 Pa to about 1,379 Pa), valves 10 will at least partially open to an open state to allow gas to escape from package 11 as illustrated by gas-flow directional arrows 115 in FIG. 2 and through valves 10 via gas flow path 41. In the embodiments of valves 10, force applied through vents 33, 37, 45 and against cover layer 39 second side 81 along gas flow path 41 causes at least partial separation of cover layer 39 from strap 43 or from base layer 35, 35a first side 55 so that valves 10 are in the open state such as in the examples of FIGS. 8-9 and 13 as previously described. The force which generates pressure within package 11 could be a force applied to package walls 15 such as by stacking packages 11 atop the other as in FIG. 1 or otherwise by pressing against walls 15.

Flexure of cover layer 39 may allow complete, partial, or undulating separation of cover layer 39 from strap 43 or from base layer 35, 35a to open gas flow path 41, allowing gas to escape from package 11 when valves 10 are in the open state. Most typically, there will be a gradual undulating movement of cover layer 39 away from and toward strap 43 or base layer 35 as individual gas bubbles pass between cover layer 39 and strap 43 or base layer 35, 35a. FIGS. 8-9 and 13 represent exaggerated illustrations of the opening.

Valves 10 return to the closed state position shown in the embodiments of FIGS. 7 and 12 once pressure within package 11 decreases following gas evacuation from package 11 through a valve 10 and to the ambient environment around package 11. In embodiments, the closure may occur once pressure within package 11 decreases below a predetermined and known target pressure such as about 0.010 psig to about 0.070 psig greater than ambient pressure. Such a pressure range would maintain a slight positive pressure within package 11 which would not interfere with contraction of package 11. Closure can occur because the material properties of cover layer 39 apply a force which returns cover layer 39 to its original closed state position. The force applied by cover 39 causes cover layer 39 to be relocated against strap 43 over aligned vents 33, 37, 45 or against base layer 35 and vents 33, 37 with wetting fluid 47 plated out therebetween, closing vent 45 and vent 37 returning valves 10 to the closed state of FIGS. 7 and 12.

Any remaining excess gas in package 11 can be removed through valves 10 should the differential pressure again increase above the target pressure above ambient pressure. It is possible that just a single opening of valves 10 may be required in circumstances where substantially all gas within package 11 is evacuated during the first opening cycle. However, there could be circumstances in which further opening of valves 10 would be required or would occur. Examples include any opening and reclosing of package 11 which entraps air within package 11 or circumstances wherein there is temperature increase or atmospheric pressure decrease expanding gas within package 11.

### EXAMPLES

Experimental valves were evaluated against valves provided as controls to demonstrate that the structure of the experimental valves quantitatively provides valve opening and valve closing characteristics which differ materially from those of the controls. The data show that valves according to the invention allow high volumetric gas outflow while also blocking inflow of air through the valve in a manner which is unexpectedly different from, and unlike, the controls. It had been thought that a valve which would allow such a high volumetric outflow of gas would not also be capable of closure to block inflow of air back through the valve.

The examples demonstrate that valves according to the invention have the capabilities of allowing rapid contraction of a package to which the valve is attached while also blocking contact between ambient air and product in the package once pressure within the package approaches equalization with ambient pressure. Rapid reduction of the volumetric size of the package provides for more efficient stacking, storing, palletizing, transporting, and displaying of the package while preserving the quality of the product in the package.

### Examples 1-5 Methodology

Evaluation of the control and experimental valves in Examples 1-4 was conducted in the same manner as described herein. Valve gas flow rate characteristics were determined using a Dwyer RMC-108-SSV flowmeter. Certain valve opening and closing characteristics were determined using a PVT-300 brand test unit available from Plitek LLC of Des Plaines, Illinois.

To determine the rate of gas outflow through the valves, control valves and experimental valves 10 were secured within an enclosed chamber with just two openings, a gas inlet port in a valve support platform and a gas outlet port through a chamber wall. In experiments involving flow rate determinations, each control and experimental valve 10 was secured within the chamber to the valve support platform with vent 37 (an inlet of valve 10) over and in gas-flow communication with the gas inlet port. The Dwyer flowmeter was connected to a tube attached to a nipple of the gas outlet port. Air was metered (i.e., delivered) to the gas inlet port at determined pressures of between 0.1 psig and 1.0 psig as described in each indicated example and the volumetric gas flow rate out of the enclosed chamber was determined with the Dwyer flowmeter, also as in each indicated example. Because the chamber was enclosed, the measure of gas flow out of the chamber as quantified by the Dwyer flowmeter represents the volumetric gas flow through the control valves and the experimental valves 10. Therefore, the flowmeter experiments are useful to simulate the rate of gas outflow through a valve when pressure inside a package 11 exceeds ambient pressure outside package 11 by a known amount providing a known pressure differential.

The PVT-300 is an industry-standard analytical unit purposed to quantify the pressure at which a one-way pressure relief valve opens and, alternatively, closes. The PVT-300 is capable of use with a stand-alone valve prior to application of the valve to a package and also with a valve once the valve is affixed to a package. The PVT-300 is capable of injecting small amounts of air into the vent (e.g., vent 37, 37a) of valves 10 (i.e., valves 10-10e) to simulate pressure within a package 11 so as to measure the pressure at which the valve opens responsive to a pressure increase with the valve being closed at all pressures below the opening pressure. Gas output from the PVT-300 may be in units of pounds per square inch gauge (psig), or Pascals, to represent the pressure differential between pressure within a package 11 and ambient pressure outside package 11. Determination of complete closure of valve 10 is particularly useful in the present patent application to establish that ambient air is blocked from entry into package 11 by valves 10. Therefore, the PVT-300 experiments are useful to simulate conditions under which a valve would close once pressure inside a package 11 decreases following gas evacuation.

Each test using the PVT-300 consisted of two opening and closing cycles. In the first cycle, differential pressure was increased in units of psig until the valve opened. A holding period of 60 seconds was then interposed before a second cycle in which the pressure would be increased again until the valve opens. Pressures below the opening pressure represent a closed state of the valve in which ambient air would be blocked from entering the valve.

In Examples 1-2 and 4-5, the experimental valves 10 and control valve each consisted of a base layer 35, a cover layer 39 and a strap 43 secured to base layer 35 by adhesive 90 in accordance with valve embodiment 10 of the above disclosure. In Example 3, valve 10 iteration 1 included a strap 43 while iterations 2-3 were for a valve 10b as described above that did not include a strap 43. An acrylic adhesive was used to join cover layer 39 and strap 43 to base layer 35 at attachment regions 83, 85, 87, 89 in all examples other than Example 3, iterations 2-3, in which sonic welding was implemented to join cover layer 39 to base layer 35 at attachment regions 83, 85, 87, 89.

Materials implemented for base layer 35, cover layer 39 and strap 43 in each valve 10, 10b of Examples 1-5 were as described in each example.

Each control valve and experimental valve 10, 10b (FIG. 11) included a wetting fluid 47 between cover layer 39 and strap 43 or base layer 35. Wetting fluid 47 consisted of a polydimethylsiloxane fluid in an amount of about 5 μL.

In each of Examples 1-5, base layer 35 and cover layer 39 had an identical length dimension L of 1.5 inch (38.1 mm) and a width dimension W of 1 inch (25.4 mm) defining a valve of a rectangular shape having an area of about 1.5 inch2. (967.7 mm²) Except as in Examples 4-5, each strap 43 had a length dimension L of 1.5 inch (38.1 mm) and a width dimension W of 0.5 inch (12.7 mm) providing a ratio of the area of the unsecured region 75 of cover layer 39 to the total cover area of 50%.

In Example 3, valves 10 (with a strap 43) and 10b (without a strap 43) were evaluated. Example 3, iterations 1 and 2 included a strap 43 with a length dimension L of 1.5 inch (38.1 mm) and a width dimension W of 0.5 inch (12.7 mm) providing a ratio of the area of the unsecured region 75 of cover layer 39 to the total cover area of 50%. Example 3, iterations 3 and 4 implemented a gas flow path 41 defined along base 35 with a length dimension L of 1.5 inch (38.1 mm) and a width dimension W of 1 inch (25.4 mm) providing a ratio of the area of the unsecured region 75 of cover layer 39 to the total cover area of 50%. Cover layer 39 thicknesses were varied as indicated.

According to Examples 4-5, the length dimension L of each strap 43 was 1.5 inch (38.1 mm), but the width dimension of strap 43 was modified as indicated in Table 4 to demonstrate the effect of changing the ratio of the unsecured region of cover layer 39 to the total cover area on the rate of gas outflow (Example 4) and time to evacuate gas from a package (Example 5) with such data providing quantifiable evidence of the real-world performance benefits of valves according to the invention.

Base layer 35, cover layer 39, and strap 43 (when provided) each had a thickness dimension of 2 mils (0.508 mm), except in Example 3, iteration 3, wherein the cover layer 39 had a thickness dimension of 5 mils (0.127 mm).

Each base layer 35 was provided with a single circular vent 37 having a diameter of 0.35 inch (8.89 mm). Each experimental and control valve included a particulate filter 49 with a mean pore size of 28.9 μm across vent 37 secured to second side 57 of base layer 35 by acrylic adhesive 51 identical to adhesive 91.

All experiments were conducted at a temperature of about 75° Fahrenheit (approximately 23.9° Celsius).

### Example 1

Example 1 was conducted to evaluate the gas outflow rate of valves 10 according to the invention and two control valves using the Dwyer flowmeter, all at a single selected pressure of 1 psig (6,895 Pa). The pressure is designed to simulate a gas pressure differential wherein pressure within package 11 is 1 psig greater than the ambient air pressure around package 11. The control valve of iteration 1 was entirely of polyester (PET) with base layer 35, strap 43 and cover layer 39 all of PET and the control valve of iteration 2 was identical to iteration 1 except that cover layer 39 consisted of LLDPE and PET. The inventive valve of Example 1, iteration 3, included a cover layer 39 of LDPE/EVA copolymer with an EVA content of about 8.7 wt. %. The inventive valve of Example 1, iteration 4 included a cover layer 39 of EMA with a methyl acrylate content of about 21.5 wt. %. The inventive valve of Example 1, iteration 5 included a cover layer 39 of BOPP. Table 1 indicates the Young's and Resilience moduli as well as the tensile strength at yield and elongation at break of each iteration of cover layer 39. Table 1 presents the volumetric rate of gas flow through each valve at a single differential pressure of 1 psig (6,895 Pa). The outflow is indicative of flexing of cover layer 39 to allow movement of gas along gas flow path 41 and out of the valve. Based on the actual flowrate measured for each iteration, a calculated perfect lateral orifice (i.e, a circular hole) diameter was calculated. This calculated orifice was converted to an equivalent height of opening given that the area of the orifice is the same as the rectangle defined by the unsecured region 75 of cover layer 39. The orifice and height calculations represent flexing of cover layer 39 to allow gas passage along gas flow path 41. These calculated data are provided in Table 1.

TABLE 1
Valve Flow Rate Characteristics At A Single Differential Pressure

| | Valve | | | | | | | |
|---|---|---|---|---|---|---|---|---|
| | Iteration & | | Resiliency | | | Calculated | Calculated | |
| | Cover Layer | Young's | Modulus | Tensile | | Lateral | Vertical | |
| | Material | Modulus | ASTM | Strength | Elongation | Orifice | Height of | Flowrate |
| | (2 Mill | ASTM D882 | D882 | at Yield | at Break | Diameter | Cover | (L/Min. at |
| | Thickness) | (Gigapascals) | (Joule M⁻³) | (PSI) | (%) | (Mils) | (Mils) | 1 PSIG) |
| 1 | Control 1 | 3.17 | 3 | 11500 | 125 | 59 | 5.5 | 9.4 |
| | PET | | | | | | | |
| 2 | Control 2 | 1.79 | 2 | 6500 | 80 | 51 | 4.1 | 6.9 |
| | LLDPE/ | | | | | | | |
| | PET | | | | | | | |
| 3 | LDPE/EVA | 0.02 | 18 | 2250 | 660 | 115 | 20.8 | 35.3 |
| | Copolymer | | | | | | | |
| 4 | EMA | 0.02 | 11 | 1750 | 800 | 137 | 29.5 | 49.4 |
| 5 | BOPP | 1.03 | 3 | 7500 | 140 | 103 | 16.7 | 28.2 |

As can be understood from Table 1, the inventive valves of iterations 3, 4, and 5 all greatly outperformed the control of valves of iteration 1 and 2. Valve iterations 3, 4, and 5 provided outflow of gas approximately 3.75, 5, and 3 times greater respectively than that the control valve of iteration 1, while also blocking inflow of air through each valve. Consistent with the superior outflow, the valves of iterations 3, 4, and 5 have much greater calculated lateral orifice openings and opening heights when compared with the controls of iterations 1 and 2.

Each inventive valve of iterations 3, 4, and 5 was tested for closure using the PVT-300 and it was determined that the valves of iterations 3, 4, and 5 all closed completely when the pressure applied to the valve was about 0.010 psig to about 0.070 psig greater than ambient pressure. These conditions simulate a decrease in pressure within package 11 and the valve closure which occurs at such pressures.

The data of Table 1 represents an unexpected result because it had been thought that a valve with a cover layer having properties such as those of iterations 3, 4, and 5 would have been excessively flexible and incapable of both allowing high volumetric amounts of gas outflow while also blocking gas inflow once pressure within package 11 decreases. The valves of iterations 3, 4, and 5 would enable near immediate evacuation of air from within a package 11 not possible with the controls of iterations 1 and 2 and represent excellent valves for applications where both high gas outflow and blockage of gas inflow are desired.

### Example 2

Example 2 was conducted to evaluate the gas outflow rate of the control and experimental valves of Example 1 using the Dwyer flow meter at a range of selected differential pressures of between 0.1 psig and 1.0 psig (690 Pa to 6,895 Pa). The data are presented in Table 2 which shows the gas outflow rate in units of liters per minute outflow in each row at each of the selected differential pressures.

TABLE 2
Valve Flow Rate Characteristics (L/Min.) At Different Differential Pressures

| | Valve | Column Headings: Differential Pressure (PSIG) | | | | | | | | | |
|---|---|---|---|---|---|---|---|---|---|---|---|
| | Iteration & | Rows: Flow Rate (L/Min.) | | | | | | | | | |
| | Cover Layer | 0.1 | 0.2 | 0.3 | 0.4 | 0.5 | 0.6 | 0.7 | 0.8 | 0.9 | 1.0 |
| | Material | PSIG | PSIG | PSIG | PSIG | PSIG | PSIG | PSIG | PSIG | PSIG | PSIG |
| 1 | Control 1 | 0 | 0 | 1.4 | 2.4 | 3.8 | 5.2 | 5.9 | 7.3 | 8.5 | 9.4 |
| | PET | | | | | | | | | | |
| 2 | Control 2 | 0 | 0 | 0 | 0.9 | 1.9 | 3 | 4.2 | 5.1 | 5.7 | 6.9 |
| | LLDPE/ | | | | | | | | | | |
| | PET | | | | | | | | | | |
| 3 | LDPE/EVA | 3.3 | 7.4 | 11.8 | 15 | 19.7 | 23.5 | 25.9 | 31.1 | 34 | 35.3 |
| | Copolymer | | | | | | | | | | |
| 4 | EMA | 8.1 | 12.7 | 17.9 | 22.1 | 27.3 | 32 | 35.3 | 39.5 | 45.2 | 49.4 |
| 5 | BOPP | 1.7 | 4.6 | 7.1 | 9.4 | 12.7 | 16.5 | 18.8 | 21.7 | 25.4 | 28.8 |

As shown in Table 2, the experimental valves of iterations 3, 4, and 5 all opened once the pressure differential reached about 0.1 psig whereas the controls remained closed. Valve iterations 3, 4, and 5 of Example 2 greatly outperformed the controls of iterations 1 and 2 at all pressure differentials between 0.1 through 1.0 psig (690 Pa to 6,895 Pa) in terms of gas outflow rates. The outflow is indicative of flexing of cover layer 39 to allow movement of gas along gas flow path 41 and out of the valve. It would be expected that valve iterations 3, 4, and 5 would have greater calculated lateral orifice openings and opening heights as compared with the control. The experimental valves of iterations 3, 4, and 5 all closed when the pressure applied to the valve was only about 0.010 psig to about 0.070 psig greater than ambient pressure as determined by a separate confirmatory test using the PVT-300.

These data further demonstrate that valves according to the invention are sensitive to small differential pressures and permit rapid gas outflow at those small pressure differentials which would be desirable when seeking to provide a package which can be contracted quickly to have a more compact volume. The data of Table 2 again exemplifies an unexpected result because the experimental valves unexpectedly provided both high volumetric amounts of gas outflow while also blocking gas inflow.

### Example 3

Example 3 was conducted to demonstrate that valves according to the invention are effective at evacuating large volumetric amounts of gas in valve iterations both including a strap 43 (e.g., valves 10, 10a), and not including a strap 43 (e.g., valve 10b) and across a range of cover layer thicknesses between the first and second sides 79, 81 of cover layer 39. Each of iterations 1-3 of Example 3 included a cover layer 39 of LDPE/EVA copolymer with an EVA content of about 8.7 wt. %. Each valve was evaluated using the Dwyer flowmeter for gas outflow rate in units of liters per minute in each row as described above at each of the selected differential pressures. The data are provided in Table 3. Asterisks indicate that the valve was closed at the indicated pressure differential as indicated by the absence of flow data measured with the Dwyer flowmeter. A separate test with the PVT-300 to simulate a decrease of pressure within package 11 was also provided.

TABLE 3
Valve Flow Rate Characteristics (L/Min.) With/Without Straps And Based On Selected
LDPE/EVA Cover Layer Thicknesses At Selected Differential Pressures

| | | | Column Headings: Differential Pressure (PSIG) | | | | | | | | | |
|---|---|---|---|---|---|---|---|---|---|---|---|---|
| | Cover Layer | | Rows: Flow Rate (L/Min.) | | | | | | | | | |
| | Thickness | Strap | 0.1 | 0.2 | 0.3 | 0.4 | 0.5 | 0.6 | 0.7 | 0.8 | 0.9 | 1.0 |
| | (Mils) | Provided? | PSIG | PSIG | PSIG | PSIG | PSIG | PSIG | PSIG | PSIG | PSIG | PSIG |
| 1 | 2 | Yes | 3.3 | 7.4 | 11.8 | 15 | 19.7 | 23.5 | 25.9 | 31.1 | 34 | 35.3 |
| 2 | 2 | No | * * * | * * * | 10.4 | 15.1 | 17.9 | 21.2 | 24.5 | 27.4 | 30.2 | 33.0 |
| 3 | 5 | No | * * * | * * * | 10.4 | 14.2 | 16.0 | 18.9 | 20.8 | 22.7 | 25.5 | 28.3 |

As demonstrated in Table 3, each valve iteration 1-3 with and without a strap, greatly outperformed the control valves shown as iterations 1 and 2 of Tables 1 and 2 in terms of gas outflow rates. Valve iterations 1-3 of Table 3 were also effective with a cover layer 39 having both 2 and 5 mil thicknesses. It would be expected that other thicknesses of cover layer 39 would provide rapid gas outflow, including thicknesses in the range of about 0.0005 inch to about 0.010 inch (about 0.0127 mm to about 0.254 mm). Gas outflow rates of about 28 to over about 35 liters per minute at a pressure differential of 1 psig represent excellent rates of outflow that would rapidly deflate any package to which the valve was attached. The outflow is indicative of flexing of cover layer 39 to allow movement of gas along gas flow path 41.

Each valve of Example 3 iterations 1-3 closed completely to block inflow of air through the valve once the pressure differential was about 0.010 psig to about 0.070 psig greater than ambient pressure as determined by the separate test using the PVT-300. These data exemplify a one-way pressure relief valve with properties of both high gas outflow and with gas inflow blocked.

The data are indicative of valves which provide rapid gas outflow at small differential pressures, which would be desirable when seeking to provide a package which can be contracted quickly to have a more compact package volume while also blocking ambient air inflow back through the valve. These data represent an unexpected result.

### Example 4

Example 4 demonstrates that valve flow rate characteristics may be influenced by the ratio of the area of the unsecured region 75 of cover layer 39 to the total area of cover layer 39 and that a suitable range of the ratio of the area of the unsecured region 75 of the cover layer 39 to the total area of the cover layer 39 may be about 25% to about 50%.

According to Example 4, eight experimental valves were manufactured with a rectangular shape having a length dimension L of 1.5 inch (38.1 mm) and a width dimension W of 1.0 inch (25.4 mm) and a total area, and cover area, of 1.5 inch² (967.7 mm²). As in Table 4A, strap 43 width ranged from 0.5 inch (12.7 mm) (iteration 1) to 0.875 inch (22.2 mm) (iteration 4). According to Table 4B, no strap 43 was provided and the width of unsecured region 75 of cover layer 39 ranged from 0.5 inch (12.7 mm) (iteration 5) to 0.875 inch (22.2 mm) (iteration 8). Cover layer 39 was of LDPE/EVA copolymer with an EVA content of about 8.7 wt. %. Cover layer 39 was secured to attachment regions 87, 89 of base layer 35 on opposite sides of strap 43 by acrylic adhesive 91 in iterations 1-4. In iterations 1-4, cover layer 39 unsecured region 75 abutted strap 43 with a wetting fluid 47 between the cover layer 39 and strap 43 and around vent 45. In iterations 5-8, cover layer 39 was welded to base layer 35 with no strap therebetween so that cover layer 39 unsecured region 75 abutted base 35 with a wetting fluid 47 between the cover layer 39 and base 35 and around vent 37.

Each valve was evaluated for gas outflow rate in units of liters per minute using the Dwyer flowmeter as described above at each of the selected differential pressures indicated in Tables 4A and 4B.

### Tables 4A and 4B

### Valve Flow Rate Characteristics (L/Min.)

### Based on Ratio of Unsecured Cover Layer Area to Total Cover Layer Area

TABLE 4A
Flow Rate At Various Differential Pressures For Valve Including A Strap

| | | | Column Headings: Differential Pressure (PSIG) | | | | | | | | | |
|---|---|---|---|---|---|---|---|---|---|---|---|---|
| | Strap | Percent | Rows: Flow Rate (L/Min.) | | | | | | | | | |
| | Width | Unsecured | 0.1 | 0.2 | 0.3 | 0.4 | 0.5 | 0.6 | 0.7 | 0.8 | 0.9 | 1 |
| | (Inch) | Region | PSIG | PSIG | PSIG | PSIG | PSIG | PSIG | PSIG | PSIG | PSIG | PSIG |
| 1 | 0.5 | 50.0 | 3.3 | 7.4 | 11.8 | 15.0 | 19.7 | 23.5 | 25.9 | 31.1 | 34.0 | 35.3 |
| 2 | 0.375 | 37.5 | 1.7 | 4.2 | 7.2 | 9.4 | 13.2 | 16.0 | 17.9 | 20.3 | 22.7 | 26.0 |
| 3 | 0.25 | 25.0 | 0.8 | 1.9 | 3.0 | 4.4 | 5.2 | 6.6 | 8.0 | 9.2 | 9.9 | 11.8 |
| 4 | 0.125 | 12.5 | 0.8 | 1.3 | 1.6 | 2.0 | 2.4 | 2.5 | 2.8 | 3.2 | 3.6 | 3.9 |

TABLE 4B
Flow Rate At Various Differential Pressures For Valve Not Including A Strap

| | Unsecured | | Column Headings: Differential Pressure (PSIG) | | | | | | | | | |
|---|---|---|---|---|---|---|---|---|---|---|---|---|
| | Region | Percent | Rows: Flow Rate (L/Min.) | | | | | | | | | |
| | Width | Unsecured | 0.1 | 0.2 | 0.3 | 0.4 | 0.5 | 0.6 | 0.7 | 0.8 | 0.9 | 1 |
| | (Inch) | Region | PSIG | PSIG | PSIG | PSIG | PSIG | PSIG | PSIG | PSIG | PSIG | PSIG |
| 5 | 0.5 | 50 | 0.0 | 5.7 | 10.4 | 15.1 | 17.9 | 21.2 | 23.6 | 27.4 | 29.3 | 33.0 |
| 6 | 0.375 | 37.5 | 0.0 | 2.4 | 3.8 | 5.7 | 7.6 | 9.4 | 11.8 | 13.2 | 15.6 | 17.9 |
| 7 | 0.25 | 25 | 0.0 | 0.9 | 2.4 | 3.3 | 4.7 | 5.7 | 6.6 | 7.6 | 8.5 | 9.9 |
| 8 | 0.125 | 12.5 | 0.0 | 0.0 | 0.0 | 0.0 | 0.0 | 0.5 | 0.9 | 1.2 | 1.4 | 1.9 |

Tables 4A and 4B demonstrate that an experimental valve implementing an unsecured region 75 with an area ratio of about 25% to about 50% of the total cover layer 39 area has excellent characteristics of both high volumetric gas flow rates across a range of differential pressures. After the initial opening, valve closing was determined to occur at pressure differentials of about 0.010 psig to about 0.070 psig greater than ambient simulating valve closure responsive to a decrease in pressure within a package 11 as determined by the separate test using the PVT-300.

As indicated by iterations 1-8 of Tables 4A and 4B, the gas flow rate decreases as a greater percentage of the cover layer 39 is secured to the base layer (e.g., base 35), thereby reducing the flexibility of the cover layer by decreasing the area of the unsecured region 75 of cover 39.

Iterations 1-3 and 5-7 in particular are indicative of a valve which is both sensitive to differential pressures as low as 0.2 psig (1,379 Pa) and which permits flexing of cover layer 39 to provide rapid gas outflow along gas flow path 41 in a manner which would be desirable when seeking to provide a package 11 with a compact volume.

### Example 5

Example 5 demonstrates that valves according to the invention provide for rapid deflation of a flexible package to which a valve is attached. For purposes of Example 5, valves identical to valve iterations 1-4 of Example 4 were tested to determine the time to deflate a package. Cover layer 39 was of LDPE/EVA copolymer with an EVA content of about 8.7 wt. %. Example 4 previously established that the valve iterations 1-8 were each effective in completely closing to block inflow of air through the valve.

The experiments of Example 5 were conducted in the following manner. Initially, a representative bag-type package was selected. Each package consisted of a closed bag of flexible high density polyethylene material filled solely with air. Each bag had a volumetric size of 1,440 inch³ with length, width, and depth dimensions of 18×16×5 inches.

Next, one valve according to iterations 1-4 of Example 4 was affixed to a separate package. Vents 37, 45 of base layer and strap vents were aligned with vent 33 in each package.

Next, each package with a valve attached was placed on its side on a horizontal solid surface. A 50 pound weight was placed atop the package. Observations were then recorded of the time in seconds required for the weight to move downward a distance of 2.5 inches, replicating a situation in which bags are stacked atop one another after loading and closing. The data are presented in Table 5.

TABLE 5
Time To Deflate Package Based On Ratio Of Unsecured
Cover Layer Area To Total Cover Layer Area

| | | Ratio of | | |
|---|---|---|---|---|
| | Strap | Unsecured Cover | Seconds to Deflate | |
| | Width | Layer Area to Total Cover | 2.5 Inch Movement of Weight | |
| | (Inch) | Layer Area (%) | (Seconds) | |
| 1 | 0.5 | 50.0 | 20 | seconds |
| 2 | 0.375 | 37.5 | 60 | seconds |
| 3 | 0.25 | 25.0 | 180 | seconds |
| 4 | 0.125 | 12.5 | 600 | seconds |

Consistent with Example 4, Table 5 demonstrates that experimental valves have excellent high volumetric gas flow rate characteristics enabling rapid deflation of a package. The outflow is again indicative of flexing of cover layer 39 to allow movement of gas along gas flow path 41. Valve iteration 1 having a ratio of 50% unsecured cover layer area to total cover layer area demonstrated package deflation in just 20 seconds. As indicated by valve iterations 2-4, the gas flow rate decreases as a greater percentage of the cover is secured to the base layer, thereby reducing the area of unsecured region 75 of cover. Iterations 1-3 in particular are indicative of a valve which enables outflow of high volumetric amounts of gas from the package. Such outflow would be highly desirable when seeking to provide a package capable of contacting quickly to a more compact volume.

The foregoing description is provided for the purpose of explanation and is not to be construed as limiting the invention. While the invention has been described with reference to preferred embodiments or preferred methods, it is to be understood that the words which have been used herein are words of description and illustration, rather than words of limitation. Section headings are non-limiting and are provided for the reader's convenience only. Furthermore, although the invention has been described herein with reference to particular structure, methods, and embodiments, the invention is not intended to be limited to the particulars disclosed herein, as the invention extends to all structures, methods and uses that are within the scope of the appended claims. The disclosed high-outflow one-way pressure relief valves may address some or all of the problems previously described.

A particular embodiment need not address all of the problems described, and the claimed high-outflow one-way pressure relief valves should not be limited to embodiments comprising solutions to all of these problems. Further, several advantages have been described that flow from the structure and methods; the present invention is not limited to structure and methods that encompass any or all of these advantages. Those skilled in the relevant art, having the benefit of the teachings of this specification, may effect numerous modifications to the invention as described herein, and changes can be made without departing from the scope and spirit of the invention as defined by the appended claims. Furthermore, any features of one described embodiment can be applicable to the other embodiments described herein.

What is claimed is:

1. A high-outflow one-way pressure relief valve for rapid evacuation of gas from a flexible package, the valve comprising:
a base layer having first and second sides, an area, a peripheral edge, and a vent entirely through the base layer;
a cover layer of a flexible film material overlying the base layer, the cover layer having a first side, a second side, an area, a peripheral edge, and spaced apart portions of the first side secured with respect to the base layer second side providing an unsecured region of the cover layer therebetween which comprises about 25% to about 50% of the cover layer area, the base and cover layers defining a gas flow path from the vent to at least a peripheral edge of the cover layer between the secured portions of the cover layer and the cover and base layers, the flexible film of the cover layer having the material properties of a Young's Modulus of about 0.01 GPa to about 1.1 GPa, and a Resiliency Modulus of about 3 Jm³ to about 20 Jm⁻³; and
a wetting fluid disposed in the gas flow path.

2. The pressure relief valve of claim 1 wherein the valve opens to provide a flow rate of at least about 4.7 Liters/minute (L/min.) at a pressure differential of about 0.5 psig or greater.

3. The pressure relief valve of claim 1 wherein the valve opens to provide a flow rate of at least about 28 L/min. at a pressure differential of about 1 psig or greater.

4. The pressure relief valve of claim 2 wherein the valve opens to provide a flow rate of at least about 49 L/min. at a pressure differential of about 1 psig or greater.

5. The pressure relief valve of claim 4 wherein the valve closes to block ambient air flow into the valve when the pressure differential is about 0.010 psig to about 0.070 psig greater than ambient pressure.

6. The pressure relief valve of claim 1 wherein the cover layer has a typical value tensile strength at yield of about 850 PSI to 7500 PSI and an elongation before failure of about 140% to about 800%.

7. The pressure relief valve of claim 1 wherein the flexible film material of the cover layer is selected from the group consisting of: (a) low-density polyethylene (LDPE) copolymerized with between about 2% by weight to about 25% by weight ethylene vinyl acetate (EVA), (b) ethylene methyl acrylate copolymer (EMA) with a methyl acrylate content of about 15% by weight to about 25% by weight, and (c) biaxial oriented polypropylene (BOPP).

8. The pressure relief valve of claim 7 wherein the LDPE is copolymerized with between about 2% by weight to about 10% by weight EVA.

9. The pressure relief valve of claim 7 wherein the EMA is copolymerized with about 21% by weight to about 22% by weight methyl acrylate.

10. The pressure relief valve of claim 1 wherein the cover layer has a thickness dimension between the first and second sides of about 0.0005 inch to about 0.010 inch.

11. The pressure relief valve of claim 1 further including an adhesive on the first side of the base layer for securing the valve to a release liner and to the package.

12. The pressure relief valve of claim 11 further comprising a weld securing the spaced apart regions of the cover layer to the base layer.

13. The pressure relief valve of claim 11 further comprising:
an adhesive securing the spaced apart regions of the cover layer to the base layer;
a strap having a first side secured to the base layer between the secured regions of the cover layer by the adhesive and a second side, the strap further having a peripheral edge ending at least at the peripheral edge of the cover layer, and a vent through the strap aligned with the base layer vent, the second side of the strap spacing the unsecured region of the cover layer from the adhesive to define the gas flow path therebetween; and
the wetting fluid is in the gas flow path between the strap and the cover layer.

14. The pressure relief valve of claim 13 wherein the adhesives are selected from the group consisting of pressure-sensitive adhesives (PSAs), heat-activated adhesives, ultraviolet cured adhesives, water-based adhesives, solvent-based adhesives, and rubber-based adhesives.

15. The pressure relief valve of claim 13 wherein the base layer and the strap each define at least one port therethrough aligned with the other port for receiving the wetting fluid.

16. The pressure relief valve of claim 15 wherein the strap has a thickness dimension of about 0.0005 inch to about 0.002 inch.

17. The pressure relief valve of claim 16 wherein the base layer and the strap are of a material selected from the group consisting of polyethylene, polypropylene, and polyester.

18. The pressure relief valve of claim 1 wherein the wetting fluid is present in an amount of about 1.5 μL to about 2.3 μL and is selected from the group consisting of silicone oil, graphite-impregnated oil, food grade oil, and food grade silicone grease.

19. The pressure relief valve of claim 1 further comprising a particulate filter associated with the gas flow path.

20. The pressure relief valve of claim 19 wherein the filter comprises a filter element secured to the first side of the base layer.

21. The pressure relief valve of claim 19 wherein the filter comprises a plurality of apertures in the base layer and the apertures define the vent.
